(19) United States
(12) Patent Application Publication
(10) Pub. No.: US 2004/0181443 A1
(43) Pub. Date: Sep. 16, 2004

(54) Method and apparatus for the management of infrastructure assets, work orders,service requests, and work flows, utilizing an integrated call center, database, GIS system, and wireless handheld device

(76) Inventors: Carl A. Horton, Draper, UT (US); Jiajun Liu, Sandy, UT (US); Brian L. Haslam, Sandy, UT (US); Sheldon Bagely, Draper, UT (US)

Correspondence Address: Melvin A. Hunn, HILL & HUNN, LLP, Suite 1440, 201 Main Street, Fort Worth, TX, 76102-3105, US

(21) Appl. No.: 10/385,983

(22) Filed: Mar. 10, 2003

(51) Int. Cl. G06F 17/60

(52) U.S. Cl. 705/8

(57) ABSTRACT

The present invention effectively integrates a call center, a database, a GIS system, and wireless handheld devices in order to improve efficiency, accuracy, and asset management.

### BACKGROUND OF THE INVENTION

1. Field of the Invention

The present invention relates in general to systems for managing municipal infrastructure assets, such as, but not limited to water and wasted water systems, and includes a front-end call center which is utilized to receive requests for service and a plurality of wireless handheld devices which are utilized in the field to facilitate work flow.

2. Background of the Invention

Prior art dispatch and work order systems rely predominately on printed work orders. This requires personnel to be dispatched from a central location and personnel must return to the central location to pick up and deliver work orders. This is highly inefficient.

### SUMMARY OF THE INVENTION

The present invention effectively integrates a call center, a database, a GIS system, and wireless handheld devices in order to improve efficiency, accuracy, and asset management.

### BRIEF DESCRIPTION OF THE DRAWINGS

The novel features believed characteristic of the invention are set forth in the appended claims. The invention itself however, as well as a preferred mode of use, further objectives and advantages thereof, will best be understood by reference to the following detailed description of the preferred embodiment when read in conjunction with the accompanying drawings, wherein:

FIG. 1 is a block diagram representation of an overview of the preferred implementation of the present invention.

FIG. 2 is a block diagram representation of the software modules on the server.

FIG. 3 is a simplified flowchart representation of the utilization of the call center module of FIG. 2.

FIG. 4 is a pictorial representation of a user interface for the call center module.

FIG. 5 is a depiction of the general module of the call center.

FIG. 6 is a view of the problems module of the call center module.

FIG. 7A is an exemplary completed detail service request.

FIG. 7B is the service request detail sheet of FIG. 7A with annotations provided to the left to explain the content of the report.

FIG. 8 identifies the utilization of the identify button 227 from the tool bar 205 of FIG. 4.

FIGS. 9A and 9B represent two of the tool bar functions of the call center module.

FIG. 20 is a flowchart representation of how service requests are processed in accordance with one preferred implementation of the present invention.

FIG. 21 is a pictorial representation of wireless portable handheld device in accordance with the preferred implementation of the present invention.

FIG. 24 depicts an alternative format for identification of service requests.

FIG. 26A is a representation of the home page associated with a particular internet-accessible database site which can be accessed utilizing the wireless portable handheld devices.

FIG. 25 is a flowchart representation of one implementation of a wireless end device in accordance with one embodiment of the present invention.

### DETAILED DESCRIPTION OF THE INVENTION

Although the invention has been described with reference to a particular embodiment, this description is not meant to be construed in a limiting sense. Various modifications of the disclosed embodiments as well as alternative embodiments of the invention will become apparent to persons skilled in the art upon reference to the description of the invention. It is therefore contemplated that the appended claims will cover any such modifications or embodiments that fall within the scope of the invention.

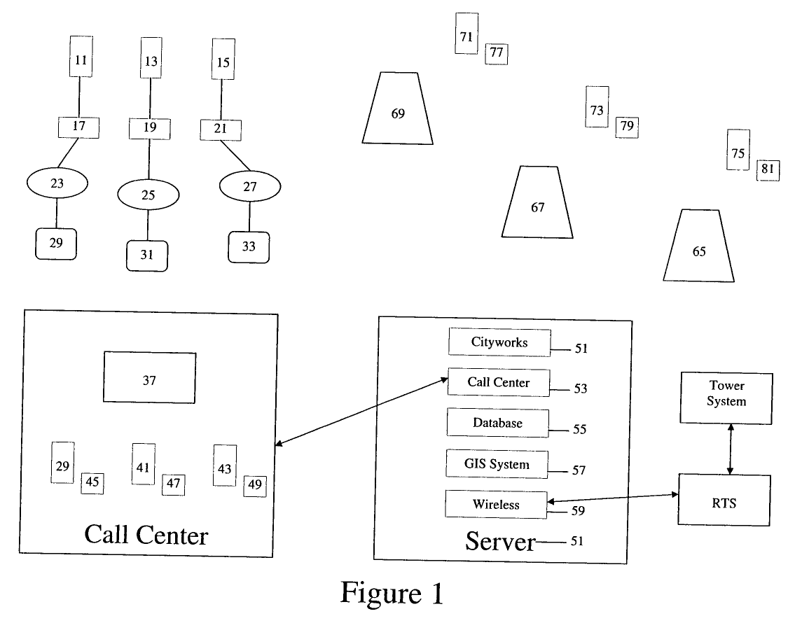

FIG. 1 is a block diagram representation of an overview of the preferred implementation of the present invention. As is shown in FIG. 1, an infrastructure management system 5 is utilized to receive requests for service, from a plurality of infrastructure users such as users 11, 13, and 15. Each of the users 11, 13, and 15 utilize a telephone 17, 19, 21 to place a call to a call center 35 associated with infrastructure management system 5. Each particular call pertains to a particular infrastructure asset 23, 25, 27 which is located at a particular location 29, 31, 33. The call center 35 includes a PBX or telephone system 37 which is utilized by a number of operators 29, 41, 43. Each operator is equipped preferably with a personal computer 45, 47, 49 which is utilized simultaneously by the operator 39, 41, 43 to access infrastructure management software which is resident on server 51. Preferably, personal computers 45, 47, 49 are networked together and may constitute “dumb” terminals, with the applications, data, and processing power residing in server 51. Alternatively, personal computers 45, 47, 49 may comprise conventional data processing systems, as opposed to “dumb” terminals.

In either case, data processing systems 45, 47, 49 have a client-server relationship with server 51. Server 51 includes a number of software modules, which will be described in much greater detail below, which cooperate to facilitate the operation of the call center, to maintain data including textual and alphanumeric data as well as geographic information system data, and various applications. More particularly, as is shown in FIG. 1, server 51 includes a suite of applications known as CityWorks 51 which provide certain functions for the management of infrastructure assets and for the management of work orders and work flow. Additionally, server 51 includes a call center 53 software suite which is utilized to facilitate the interaction between operators 39, 41, 43 and asset users 11, 13, and 15. The numeric and alphanumeric data pertaining to the municipal infrastructure is maintained in database 55. Geographic information (in the form of data representative of map information) is maintained in GIS system 57. A wireless module 59 is also provided resident on server 51. Wireless module 59 is utilized to communicate with receiver transmitter system 61 and tower system 62. Tower system 62 comprises a plurality of towers 65, 67, 69 which are dispersed throughout a service area, with each tower dedicated to one or more particular services areas. In the preferred implementation of the present invention, a CDPD protocol is utilized to communicate information between server 51 and tower system 62. The tower 65, 67, 69 are utilized to communicate with service personnel 71, 73, 75. Each of the service personnel is equipped with a wireless, portable communication device 77, 79 and 81.

In the preferred implementation, the wireless portable communication devices 77, 79, 81 comprise a Compaq iPAQ H3600 device. This is small form-factor, multimedia-centric personal digital assistant. It includes a relatively small TFT liquid crystal display (at present a 4,096 color display), with a stereo audio output to a phone jack. It includes an expansion pack connector, a built in microphone and built in speaker. Preferably, it includes a central processing unit operating at a relatively high speed (such as 206 megahertz). It preferably includes a relatively large amount of SDRM, such as 32 megabytes. Preferably, it includes a touch panel input, but also includes a number of function and application buttons and switches. In the preferred implementation, the portable wireless communication device includes a wireless communication module which is suitable for receiving and transmitting wireless messages through the tower system utilizing any conventional protocol, such as the CDPD protocol.

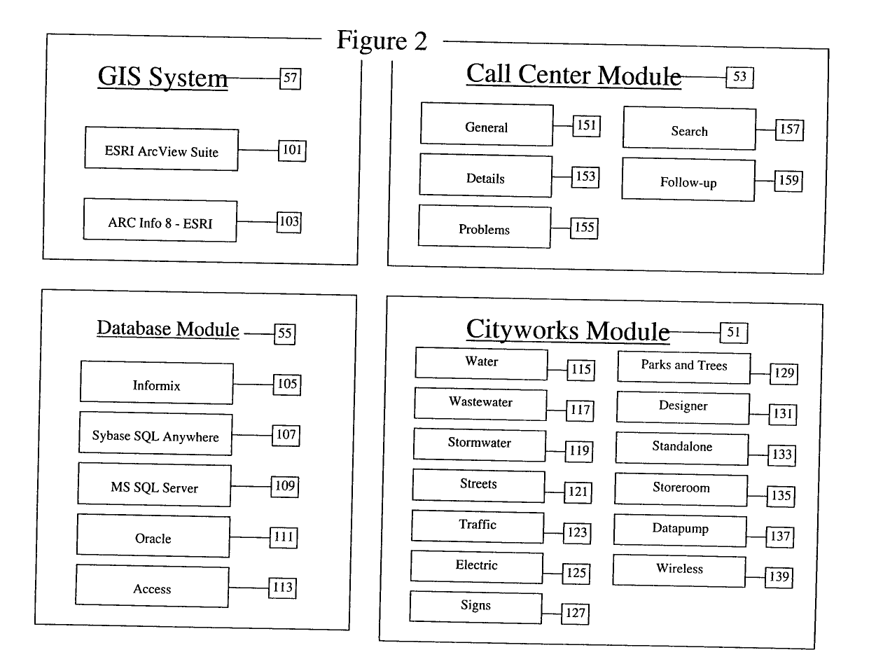

FIG. 2 is a block diagram representation of the software modules on server 51. As is shown, the GIS system is in a conventional graphical information system, but in the preferred implementation is either or both of the ESRI Arch View Suite 101 or the ESRI Arch Info 8 Suite 103. The database module 55 may be one or more of an Informix system 105, a Sybase SQL Anywhere module, an MS SQL server system 109, an Oracle System 111, or Access 2000 system 113. The CityWorks module 51 may include one or more of specialty modules individualized for the management of particular infrastructure assets. CityWorks module 51 may include water module 115, waste water module 117, storm water module 119, streets module 121, traffic module 123, electric module 125, signs module 127, parks and trees module 129. To allow customization of these individual modules, a designer module 131 is provided which allows the infrastructure manager to design customized templates, data structure, and data presentations. The CityWorks module 51 may include stand alone module 133 which allows for the creation and maintenance of a database which includes numeric and alphanumeric information only, and which does not include geographic information system data or links to geographic information system data. A store module 135 may be provided to allow for the management and control of inventories of materials and assets. Data pump module 137 may be provided to allow for the intermittent connection between server 51 and personal computers utilizing conventional modems. Wireless module 139 is provided to facilitate and control the wireless communication between server 51 and the field personnel 71, 73, 75 utilizing the portable wireless handheld devices 77, 79, 81. Call center module 53 of FIG. 2 includes software modules which facilitate the interaction between the operators which gather necessary information and the asset users (such as the residents of a city or county) that have a problem or issue or question relating to particular infrastructure asset. The call center module 53 includes several functional items which will be described below. These include a general module 151, a details module 153, a problems module 155, a search module 157 and a follow-up module 159.

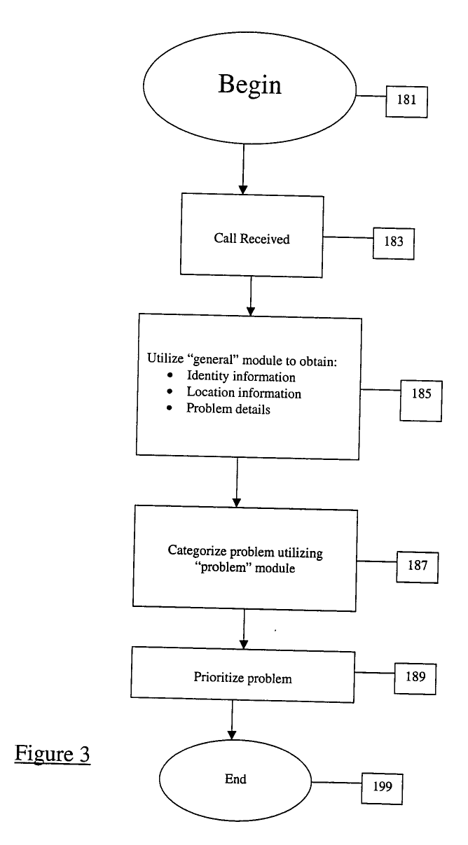

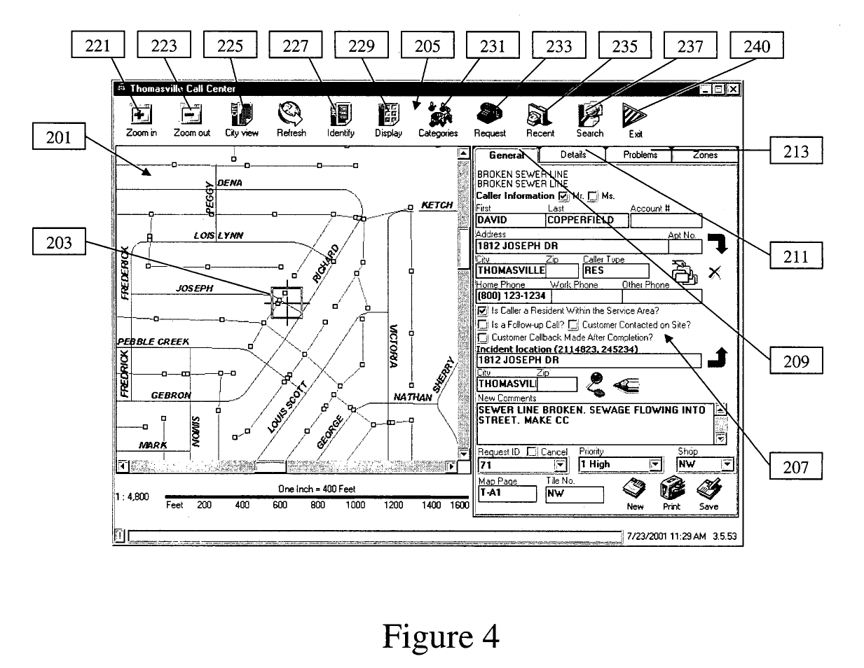

FIG. 3 is a simplified flowchart representation of the utilization of the call center module 53 of FIG. 2. As is shown, the process begins at block 181, and continues at block 183 wherein a telephone call is received by an operator. The operator utilizes the “general” module which will be described below to obtain identification information, location information, and problem details, all in accordance with block 185. Next, in accordance with block 187, the operator utilizes the “problem” module to categorize the problem to one of a number of problem types. Next, in accordance with block 189, the operator assigns a priority to the call. The process ends at block 199. The flowchart of FIG. 3 will now be better described with reference to FIGS. 4 through 16.

The call center module 51 allows an operator to quickly and easily log calls and create service requests. All of the log calls become part of a service request, and each service request is assigned to an inspector. The inspector evaluates the problem in the field to determine if further work is needed. The call center module 51 allows the call takers, inspectors, managers, and maintenance supervisors to view and update a service request at any point in the request life cycle. Utilizing the call center module 51 an operator can create the service request by logging or entering information elating to the identity of the caller, the nature of the problem, and the location of the problem. The operator may view open service requests. Open requests can be reviewed in a list format or with a may display. New calls may be attached to existing open requests. Additionally, the operator may search existing service requests using information such as a request ID, caller information, dates and time, status and personnel involved in the request.

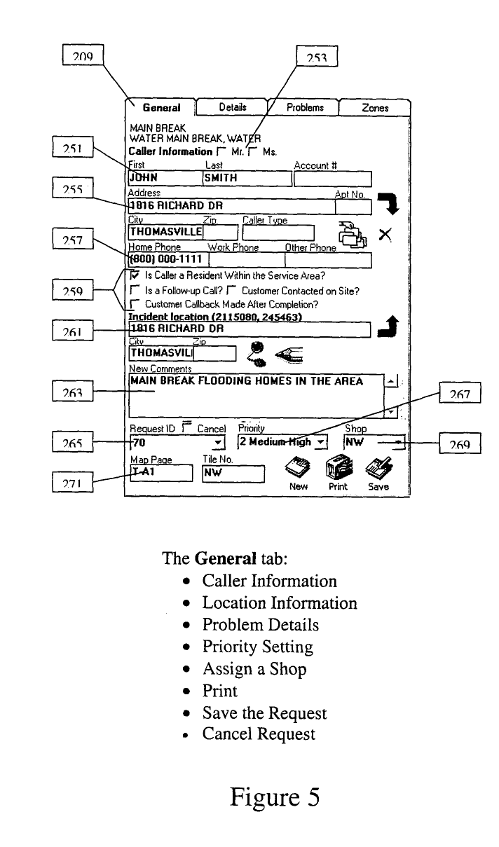

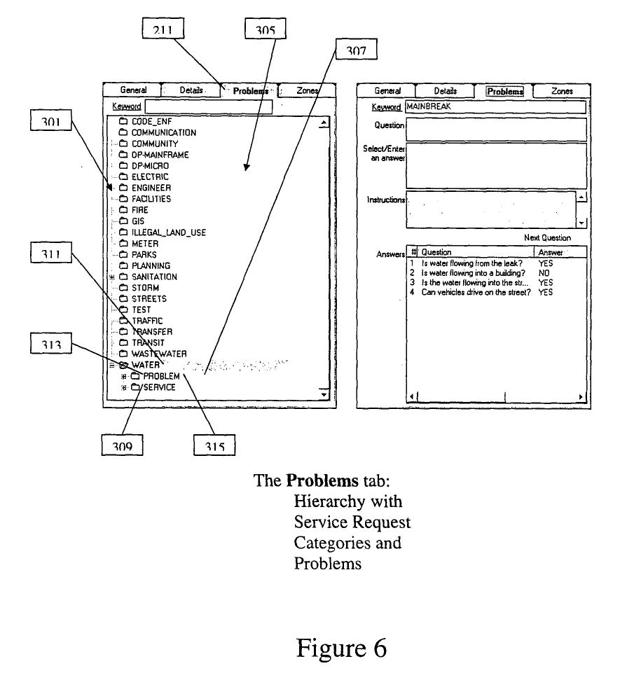

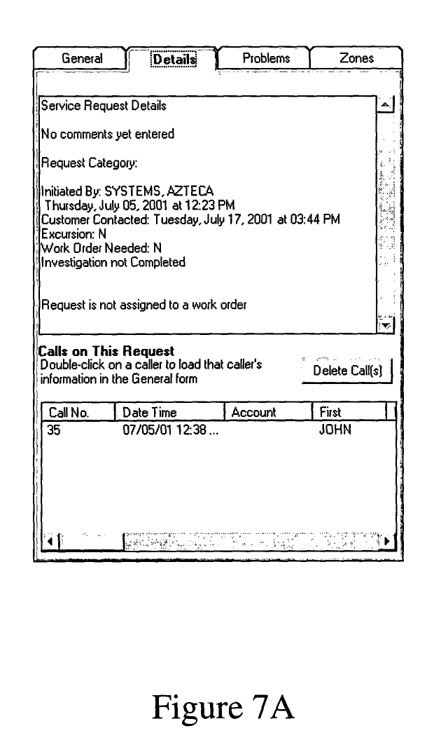

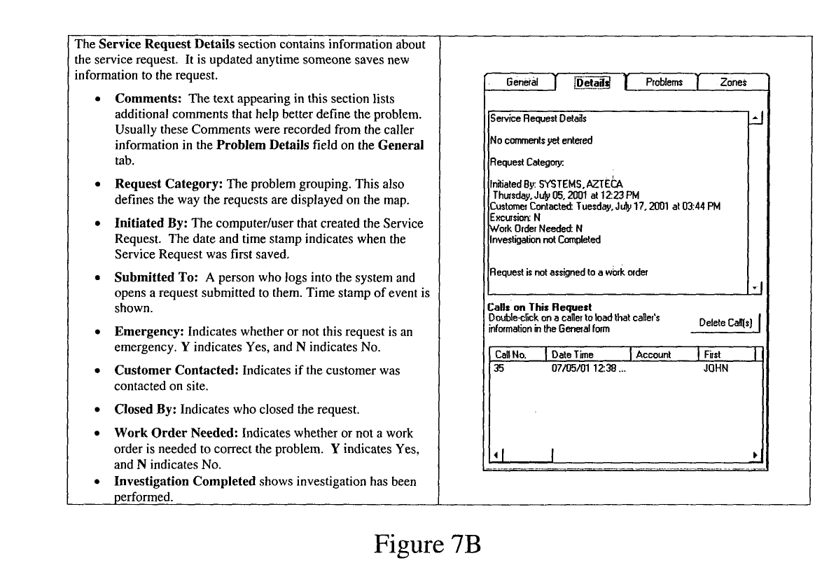

FIG. 4 is a pictorial representation of a user interface for the call center module. As is shown, the graphical user interface includes a map window 201 with map information 203 displayed therein. Furthermore, the graphical user interface includes a tool bar 205 which includes a number of icons which are representative of functions which can be performed. Additionally, the graphical user interface includes a text portion 207 which has three “layers” which may be accessed through clicking of tabs 209, 211, 213. Tab 209 includes the text “general” and will be described with reference to FIG. 5. Tab 213 includes the text “problems” will be described with reference to FIG. 6. Tab 211 includes the text “details” and will be described with respect to FIGS. 7A and 7B.

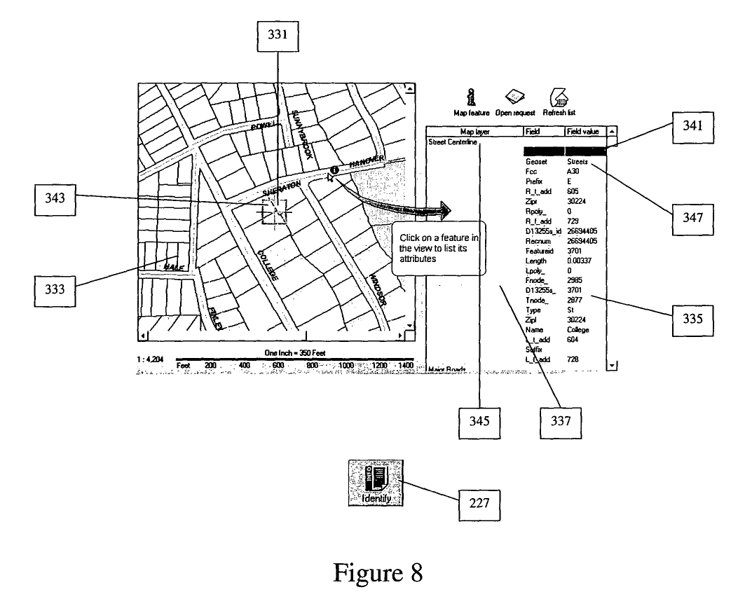

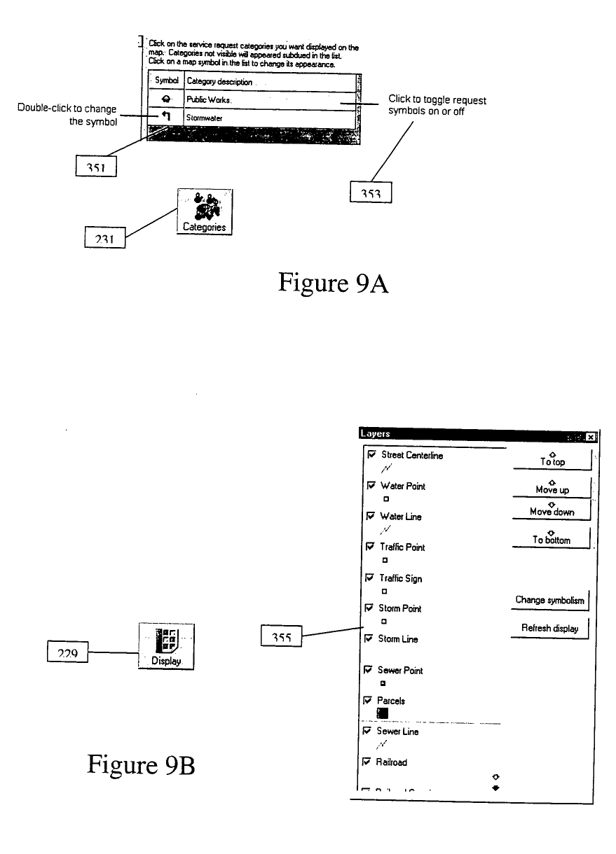

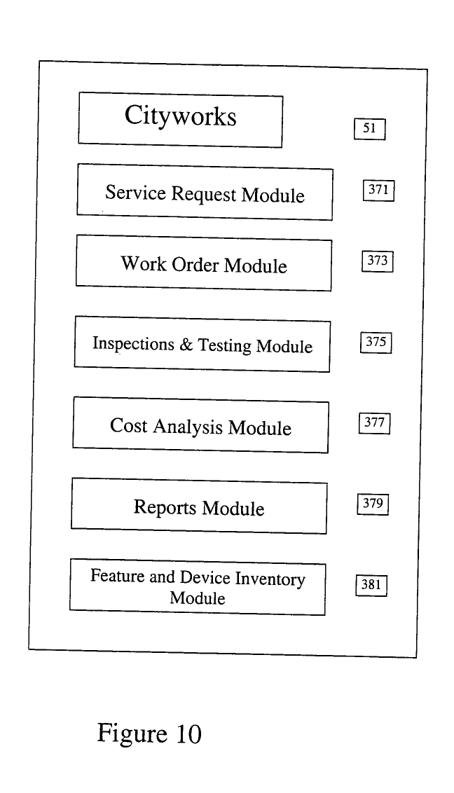

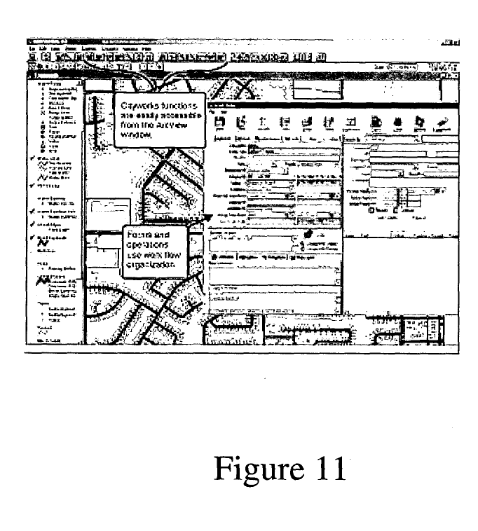

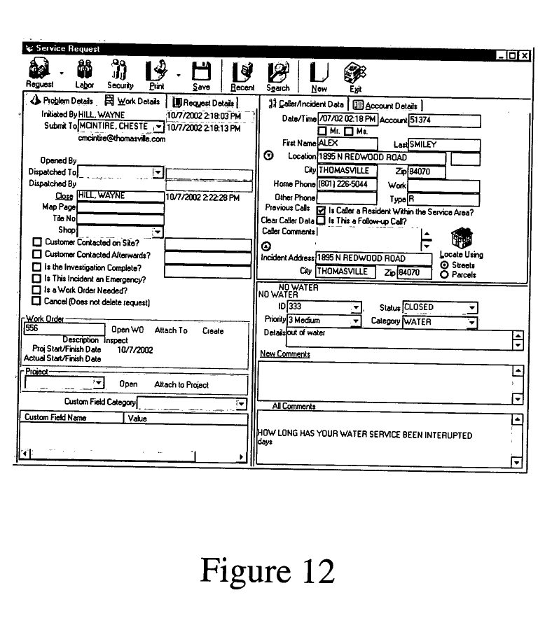

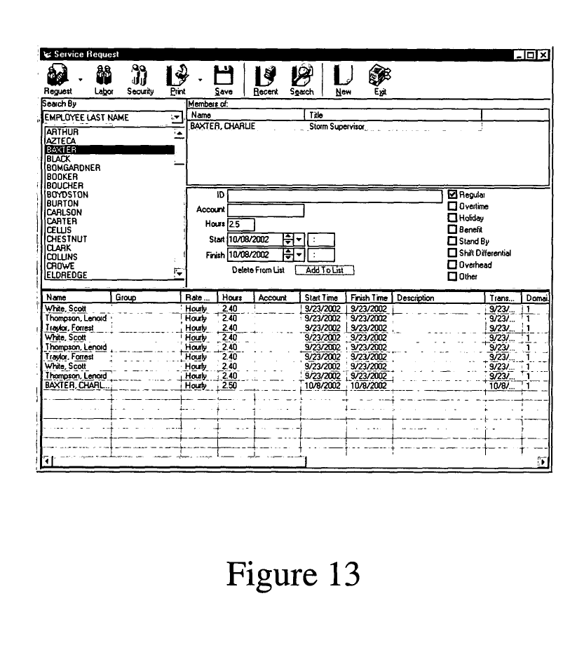

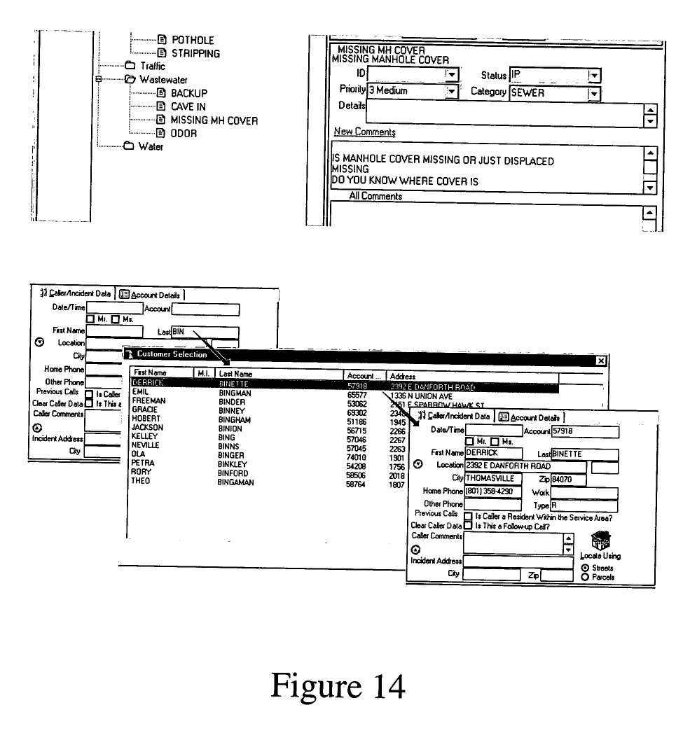

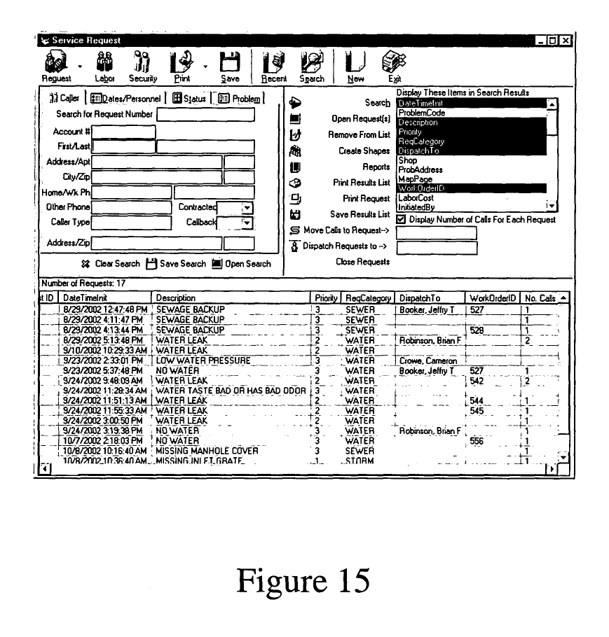

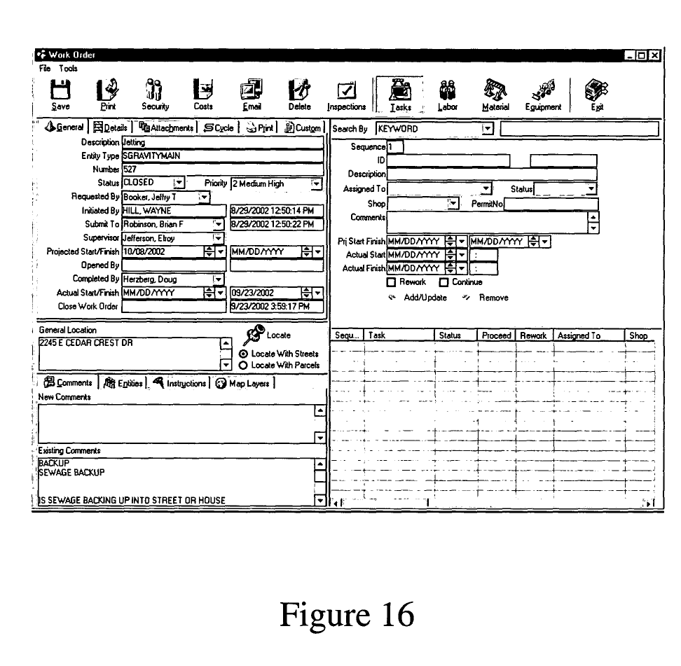

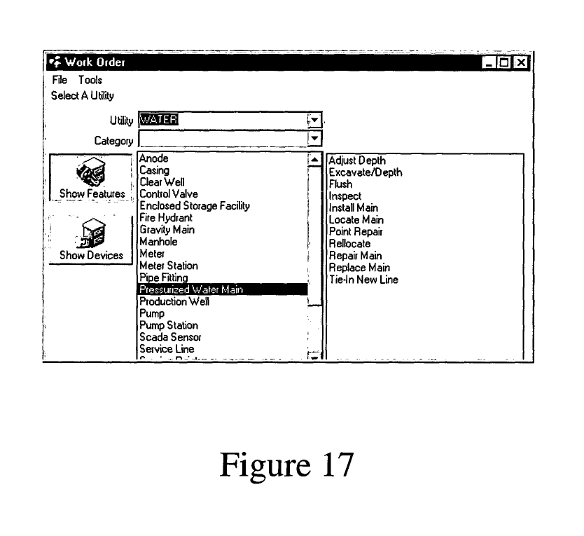

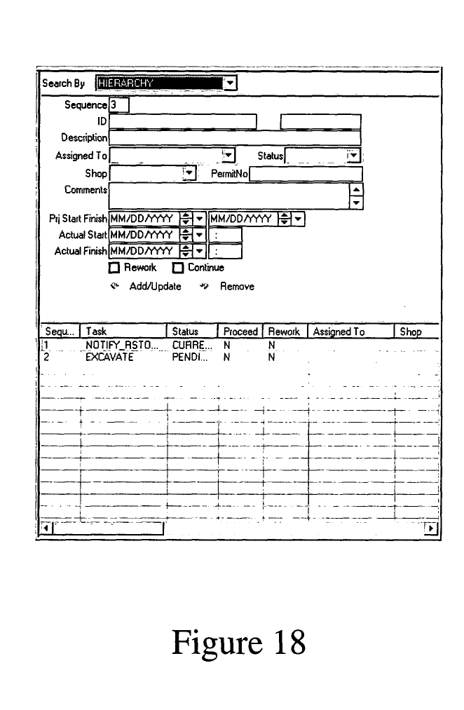

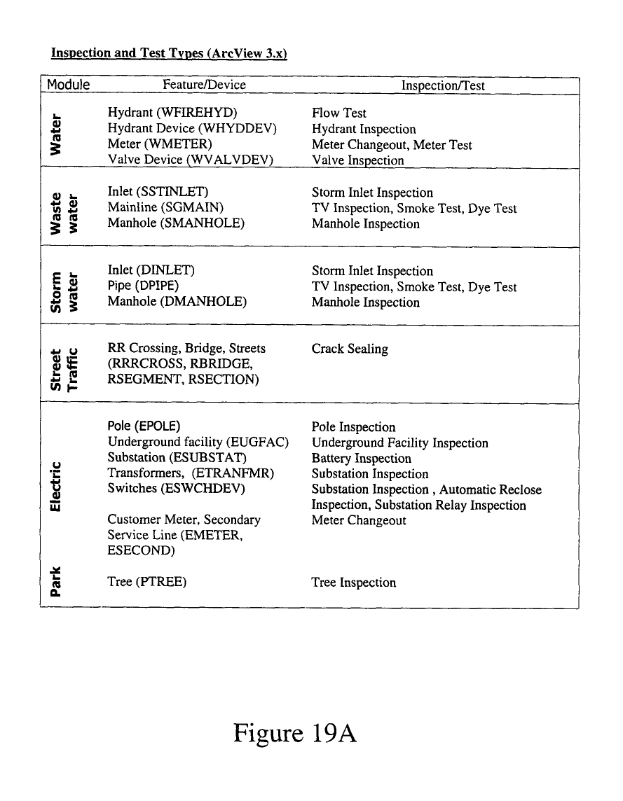

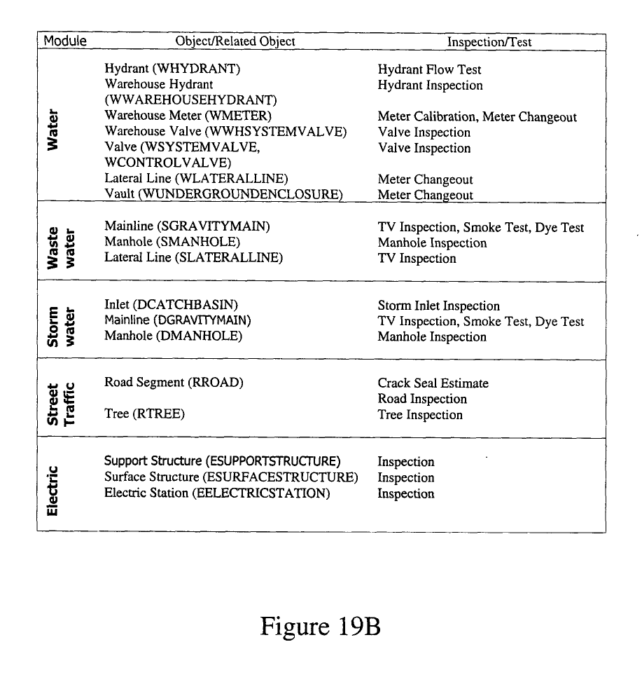

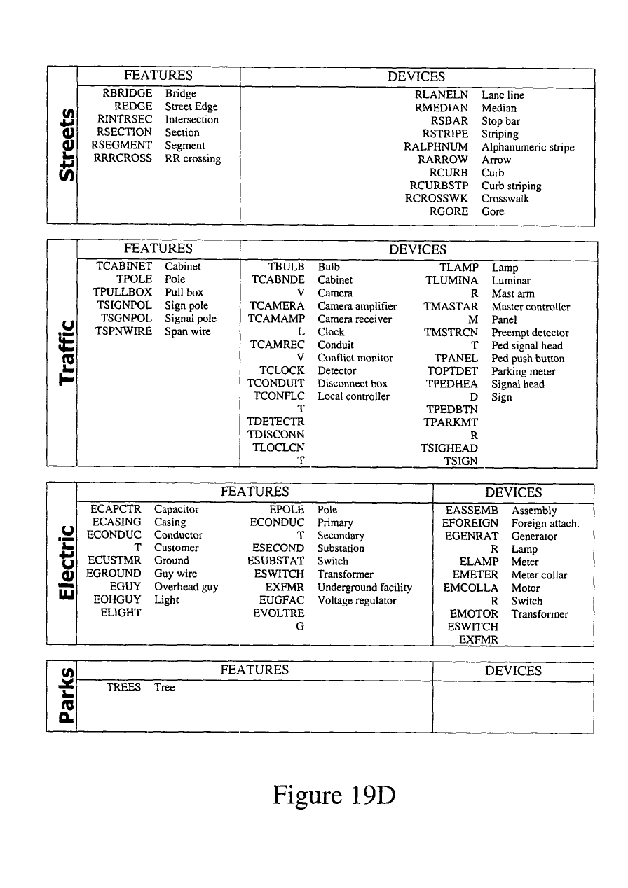

The tool bar 205 of FIG. 4 includes a number of icons. Some of these icons are utilized for navigating and/or manipulating the GIS information. Other icons are utilized to facilitate completion of the fields and check boxes of portion 207. Zoom-in button 221 and zoom-out button 223 are utilized to zoom in and out of the GIS map data 203 displayed in window 201. The city view button 225 is utilized to zoom out to the full view of the city, county or service region. The identify button 225 is utilized to highlight a point on the map, such as a water line, sewer line, street line, etc. The utilization of this function is described with respect to FIG. 8. The draw button 229 is utilized to select a theme for the display of GIS information in window 201. By clicking on a theme, a check mark will appear beside the theme and a map window will be refreshed showing the selection. This will be described with respect to FIG. 9B. The categories icon 231 allows one to select which service requests are depicted in the map display. This will be described with respect to FIG. 9A. The request button 233 is utilized to edit service request data. The recent button 235 allows the operator to view a list of service requests within a given number of hours. The search request button 237 allows the operator (and others) to search for service requests based upon a variety of search criteria. The exit button 240 is utilized to exit the application.

FIG. 5 is a depiction of the general module 209 of the call center 53. This template is utilized by the operator to enter information which identifies the caller, the location of the caller, details relating to the problem experienced by the caller, establishes a priority setting for the service request, assigns a shop possibly for the service request, and allows the operator to print the request and save the request. As is shown, identity fields 251, 253 are provided to identify the caller. Address fields 255 are provided to allow the operator to enter the address information of the caller. Check boxes 259 are provided to ensure the operator asks the caller specific questions. For example, the operator should ask the caller if he or she is a resident within the service area. Furthermore, the operator should ask the caller if this is a “follow-up” call. The operator should also ask if the customer requires a call back after completion. Incident location fields 261 are provided to allow the operator to identify the address of the reported incident. It is important that a different address be provided for the incident since a caller may be calling about a problem that is not on his or her property. A text window 263 is provided which allows the operator to provide a textual description of the problem details. Request ID field 265 is provided to allow the operator and/or the system to assign a service request ID to a particular call. Caller ID drop-down box is provided in order to allow the operator to a assign a priority to the service request. A shop drop down menu 269 is provided to allow the operator or the system to assign a particular shop to the task. Map fields 271 are provided to allow the system to assign or identify map information to the particular service request.

FIG. 6 is a view of the problems module of the call center module 53. As is shown, a hierarchical structure of folders and documents is provided which allows a relatively unskilled operator to identify the general topic 305. For example, in the view of FIG. 6, the topics include streets, traffic, transfer, transit, waste water, and water. The operator must be sufficiently well trained to be able to identify that a caller's problem relates to one of these particular topics 305. Each topic is assigned its own “folder.” Each folder contains within it a number of “documents.” In the example of FIG. 6, the operator has identified that the problem being complained of is a “water” topic problem and has accordingly opened the folder 311 associated with that topic. Once the folder is opened, subfolders are revealed. In the example, a problems subfolder 307 is revealed and a service subfolder 309 is revealed. Since the operator has determined that the caller is complaining about a problem relating to water, he or she has clicked on the problem folder 313 associated with the water topic. Once the problem folder 313 is open, a plurality of documents 315 are revealed. The operator may scan the topic headings and open the appropriate document which best describes the problem being complained of.

FIGS. 7A and 7B depict the details module of the call center module 51. FIG. 7A is an exemplary completed service request. Note that this is a textual version of the information obtained by the operator during the interaction with the user concerning a particular problem or request for service. Additionally, it shows other information which has been obtained at a later date, such as the job status, job supervisor, projected start date, etc. FIG. 7B is the service request detail sheet of FIG. 7A with annotations provided to the left to explain the content of the report.

FIG. 8 identifies the utilization of the identify button 227 from the tool bar 205 of FIG. 4. This function highlights a point 331 on map 333. A window 337 appears which provides information about that site, such as location coordinates, feature ID number, and the attributes of the feature at that point. This is illustrated in FIG. 8. The location information 339 and feature ID 341 are provided at the top of the screen. Information about the site is then provided. The feature that is highlighted through cursor 343 is posted to the field 341 which identifies the feature. At the bottom of the screen, the “theme” and shape type are described textually, at theme field 345 and shape type field 347.

FIGS. 9A and 9B depict the utilization of the categories button and the draw button from the tool bar 205 of FIG. 4. As is shown, the categories button allows the operator to select which service request he or she wants to see in the map display. The user uses check boxes to identify those categories, and then clicks the “apply” button. The draw button 229 of FIG. 9B is utilized to display a selection of themes to the display. The theme is selected by clicking on it. In the view of an example of FIG. 9B, the themes include sewer lines, sewer nodes, water lines, water nodes and parcels. When the user clicks the refresh button, a new view is shown with these themes visible. Accordingly, details about any water, sewer, or partial feature can be obtained by use of the identify button which was described above.

FIGS. 10 through 19 are utilized to depict the CityWorks software which represents a prior art system which is owned by Applicant. FIG. 10 depicts in high level overview the basic modules of the CityWorks software. These include service requests module 371, work order module 373, inspection & testing module 375, cost analysis module 377, reports module 379, and feature & device inventory module 381. FIG. 11 provides a high level overview, with annotation, of the CityWorks graphical user interface. FIGS. 12 through 15 depict service requests constructed and manipulated in accordance with the CityWorks program. The annotation of these views identifies the various fields, data elements, and other features. FIGS. 16 through 18 depict work orders utilizing the CityWorks program. These figures are also annotated to depict various data elements, features and functions. FIGS. 19A, 19B, 19C are tables which identify the systems which will be managed utilizing the CityWork's software along with the feature/device and associated inspection and testing routines.

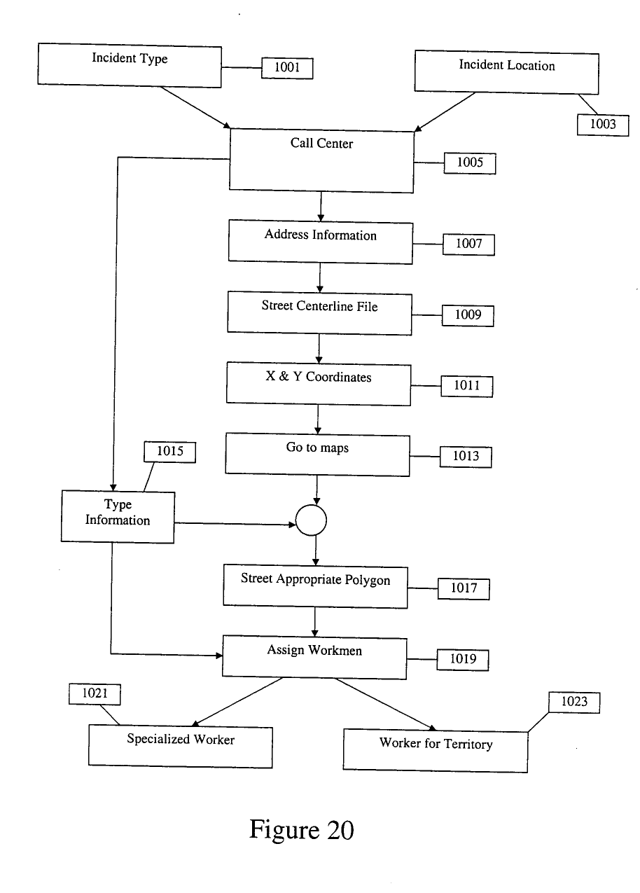

FIG. 20 is a flowchart representation of how service requests are processed in accordance with one preferred implementation of the present invention. As is shown, incident type information 1001 and incident location information 1003 are provided as an input to the call center 1005. As discussed above, the human operator obtains information from the caller which is sufficient to identify both the location of the service request and the nature of the service request. As is shown, in accordance with block 1007, address information is obtained by the operator through questioning of the caller. Once the correct address information is obtained, the application automatically retrieves the street centerline file associated with the address provided by the caller. Utilizing the centerline file, the application calculates the x and y coordinates for the asset in question, in accordance with block 1011. Next, in accordance with block 1013, the application retrieves the maps associated with the derived x and y coordinates. At this stage of the process, the incident type information 1001 is accessed and analyzed in order to determine which particular map is required. In accordance with convention in this industry, geographic information system is maintained in “polygons” which are various “views” of a particular location. For a particular address, there may be a view associated with the water assets, and a different view associated with the waste water assets. Additionally, there may be a view associated with the streets and signs in that region. Additionally, there may be a view associated with the parks and trees for that locale. Utilizing the incident type information 1001, in combination with the x and y coordinate information, the application will automatically select the appropriate polygon or “view” required by the situation. In accordance with the preferred implementation of the present invention, the application will automatically retrieve information from the database which determines the assignment of the service request to a particular worker, in accordance with block 119. Some types of problems may be assigned to specialized workers, in accordance with block 1021. More mundane problems may be assigned to the worker assigned to that particular territory for that particular subject matter. For example, a water problem for an asset at a particular location may be assigned to one particular worker, while a traffic problem for a traffic asset may be assigned to a different particular person who is charged with dealing with the traffic service requests for that locale. In accordance with the present invention, the application will automatically, and without user intervention, generate the x and y coordinates for the location, examine the incident type information 1001, select the appropriate polygon or view, and then access the database in order to automatically assign to a particular worker a particular service request associated with that particular call. This is done repeatedly throughout the day so that the service requests are allocated among the available and the appropriate service technicians. In accordance with the preferred implementation of the present invention, these service requests are automatically passed to the service technicians when each of them accesses the server utilizing his or her wireless portable handheld device.

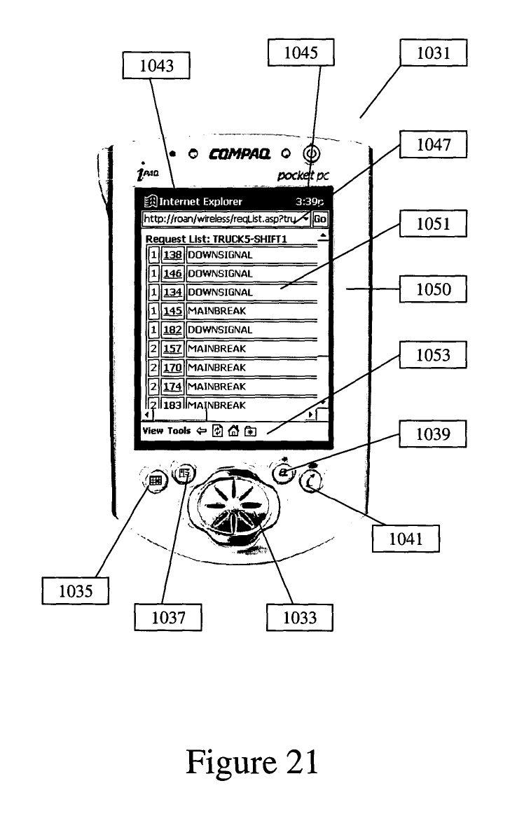

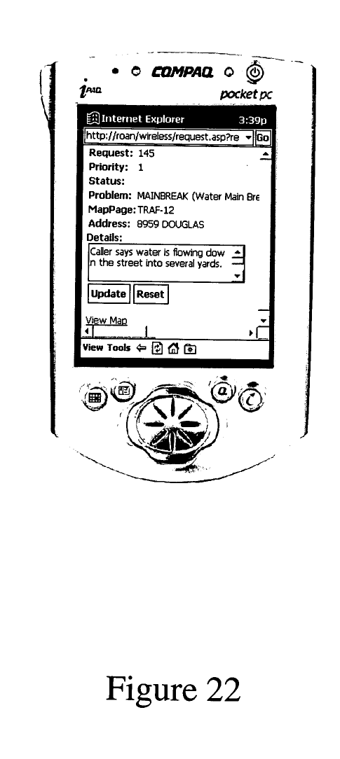

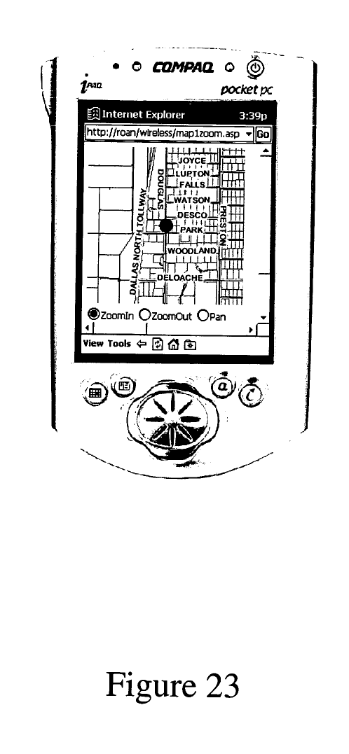

FIG. 21 is a pictorial representation of wireless portable handheld device 1050 in accordance with the preferred implementation of the present invention. As can be seen, it is a Compaq iPAQ pocket PC device which runs Internet Explorer 1043, or any other commercially available and suitable wireless browser. In accordance with the preferred implementation of the present invention, the wireless portable handheld device 1050 does not carry any customized programs whatsoever. This is extremely advantageous as the device can be used out of the box without any modification. In accordance with the preferred implementation of the present invention, all that is required is that the wireless portable handheld device 1050 be capable of making wireless internet communication with a predetermined site. As is shown in the view of FIG. 21, an address field 1047 is provided. The municipality or manager of the assets would establish an internet-addressable site which must be typed in this field before the service technician may access and utilizes the data which is maintained in a centralized location on server 51 of FIG. 1.

The wireless portable handheld device 1050 is conventional in all respects. It includes a relatively small housing and a touch sensitive display 1051 which displays various graphical user interfaces which are suitable for two way communication and interaction between the field personnel and a centralized server 51 of FIG. 1 associated with the asset management system. The wireless portable handheld device 1050 includes an internal clock which posts the time 1045. It further includes touch-sensitive icons 1053 such as the back arrow, refresh button, home button, and favorite places button. These are conventional icons associated with this particular wireless portable handheld device 1050. In accordance with the present invention, any other different wireless communication device may be utilized. The utilization of the Compaq iPAQ device is merely a design choice. Other conventional or novel wireless and portable browser devices may be utilized in accordance with the present invention.

As is shown in the view of FIG. 21, the wireless portable handheld device includes dedicated buttons 1035, 1037, 1039, 1041, and a cursor device 1033 which is utilized to move a graphical pointing device within the display area 1051. In the view of FIG. 21, a graphical user interface is provided on display 1051 which is a simple listing of service requests which have been automatically pushed from the call center, through the server, over the tower system, to the wireless handheld portable device 1050. As is shown, in the combined view of FIGS. 21, 22, and 23, the simple listing of tasks actually represents a series of links which allow the user to navigate through a series of connected internet pages which provide an increasing amount of different information relating to a particular service request. For example, considering the views of FIGS. 21, 22, and 23, if the user were to utilize the graphical pointing device 1033 to move the cursor to item number 145 entitled “main break” and then clicked on that link, the wireless handheld device would communicate through the CDPD protocol with the server device in order to display a new internet page associated with that particular service request. For example, once the item is clicked on, the view of the internet page displayed in FIG. 22 is available to the user. As is shown, this provides a considerably greater amount of information about request number 145. It identifies the priority, the nature of the problem, the map page, the address, and provides textual detail. This information is the information which was obtained from someone during interaction utilizing the call center software. If the operator needs to view a map, the link at the bottom of the screen “view map” may be clicked on which will generate a map such as that depicted in the view of FIG. 23. In the view of FIG. 23, the map data is displayed on the small display. The user may select certain map functions such as zoom-in, zoom-out, and pan, and may utilize the graphical pointing device in order to obtain more or different map data.

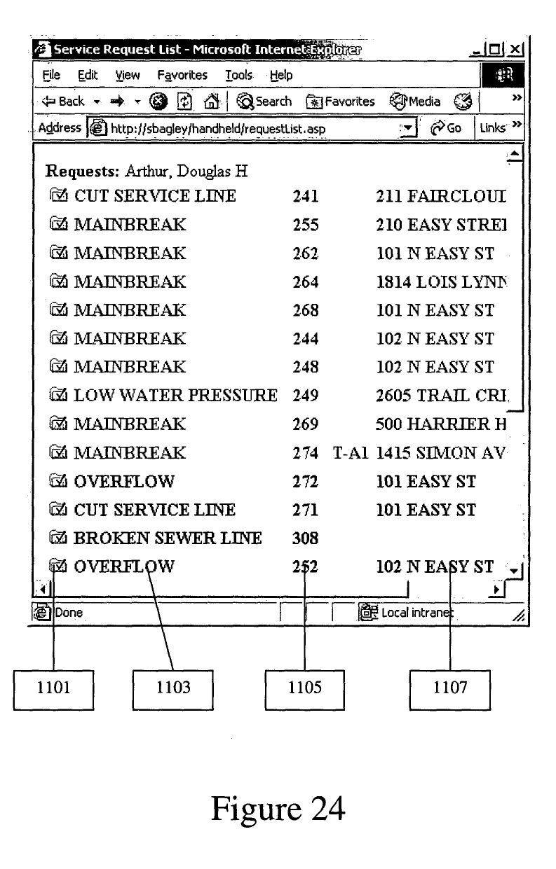

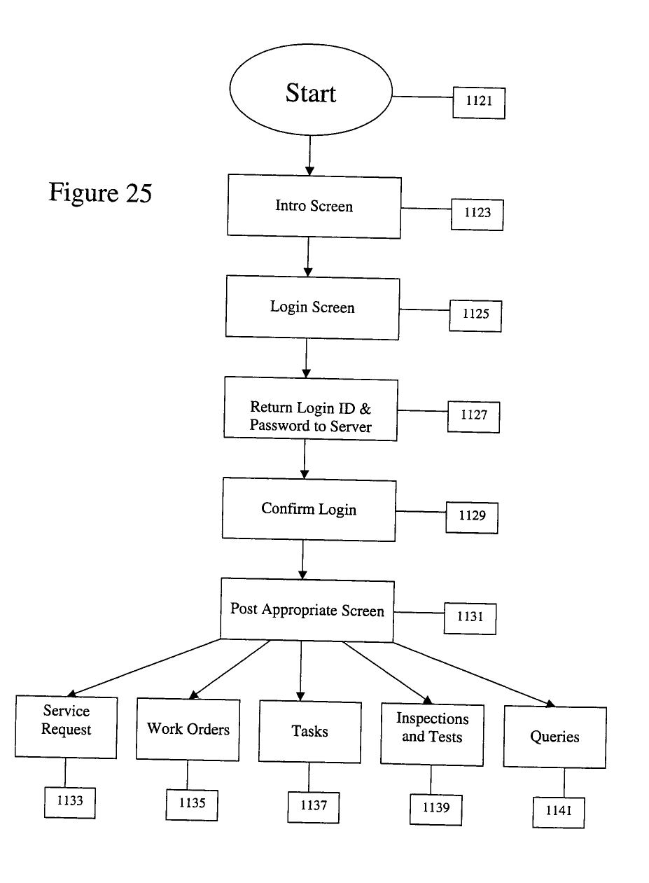

FIG. 24 depicts an alternative format for identification of service requests. In this format, four columns of data are provided. Column 1101 is a column for an icon which is representative of the nature of the item on the list. All the items on this listing are requests for service. Column 1103 is provided for a brief description of the service request. Column 1105 is provided to display a task number associated with the service request. Column 1107 is provided to allow the transmission of additional or different information relating to the service request. This screen may be viewable at the server or the network associated with the server, and it may be transmitted and update over the wireless connection between the tower system and the wireless portable handheld device. With the example of FIGS. 21, 22, 23 and 24 in mind, we will now more closely examine the process of utilizing a wireless communication device to transmit information to field personnel and to receive information back from field personnel.

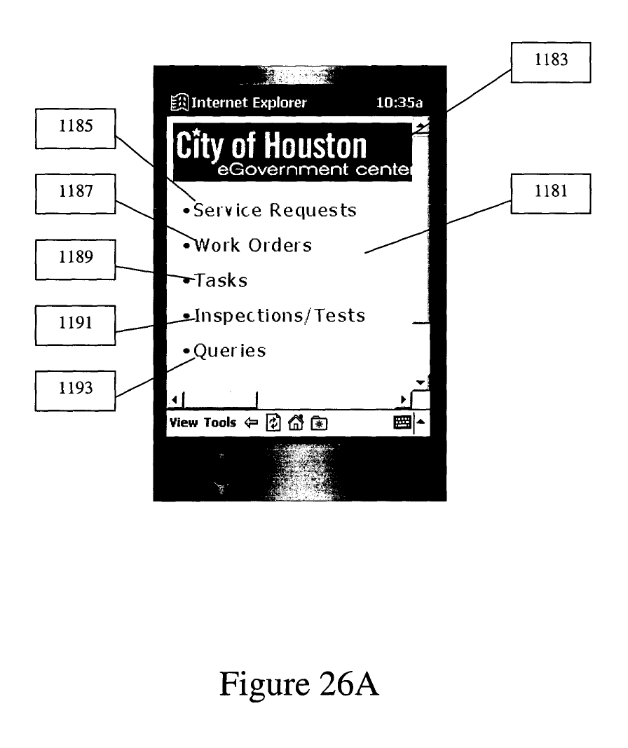

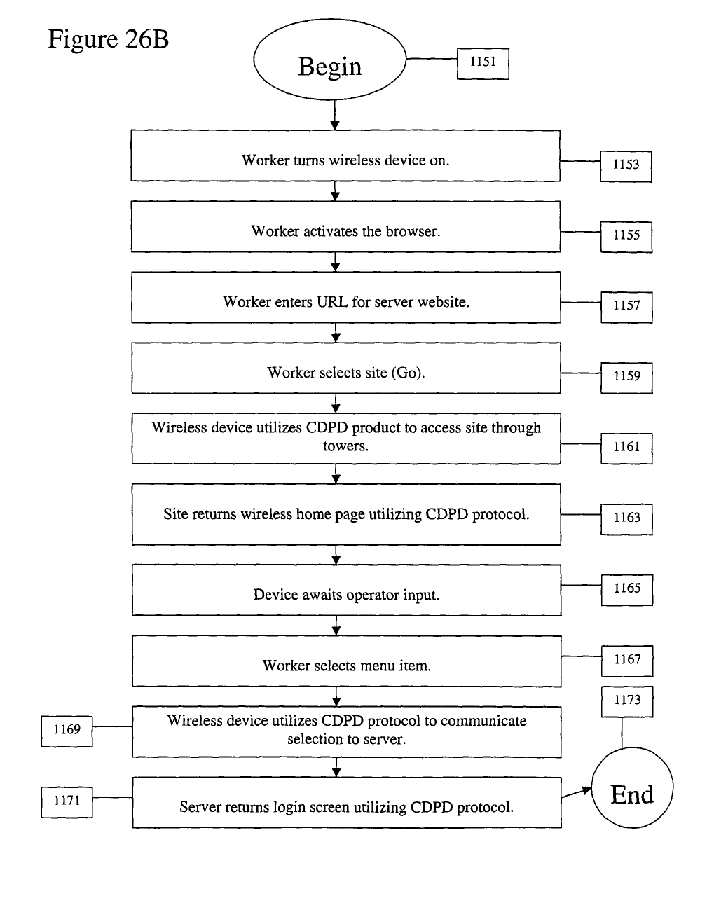

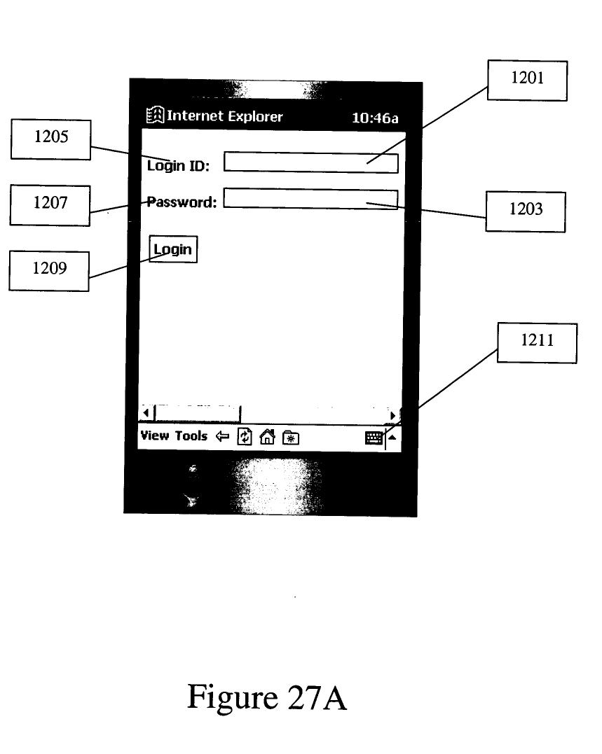

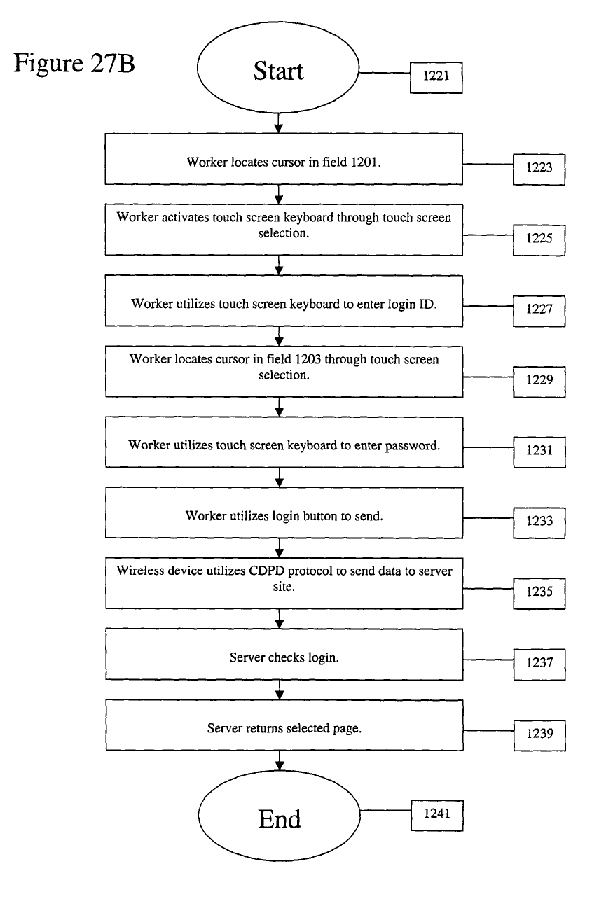

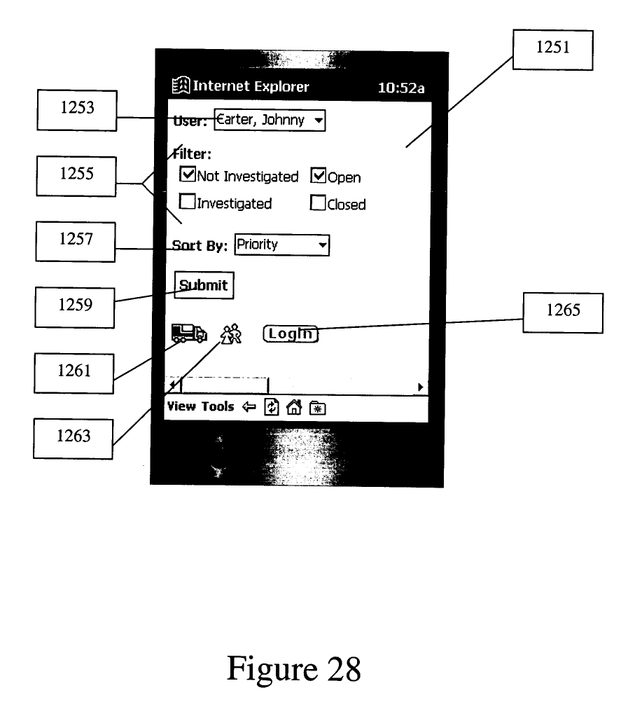

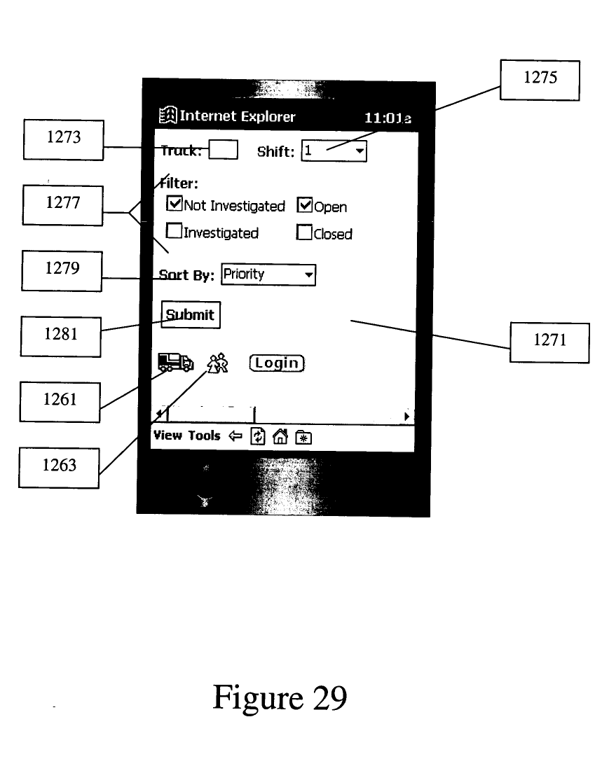

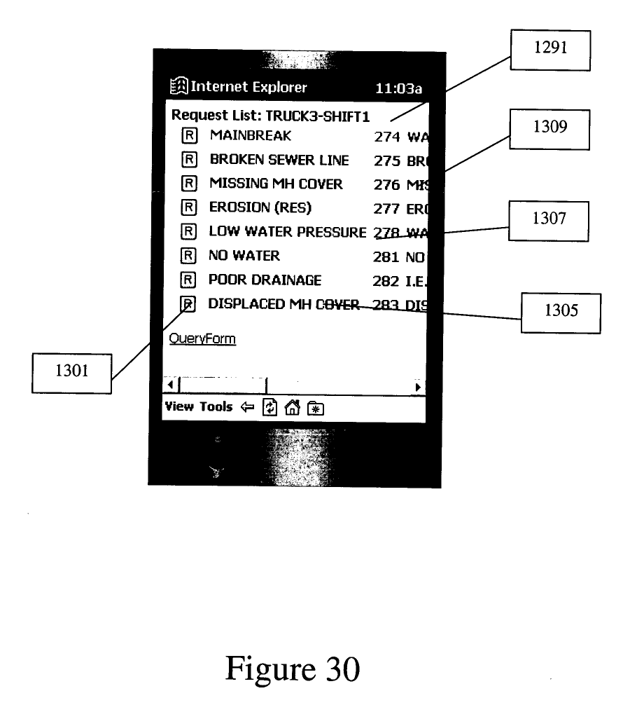

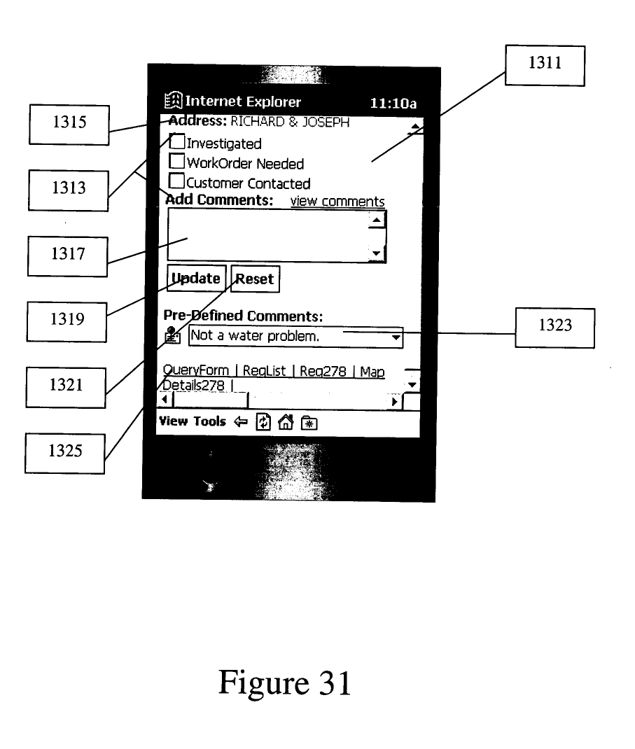

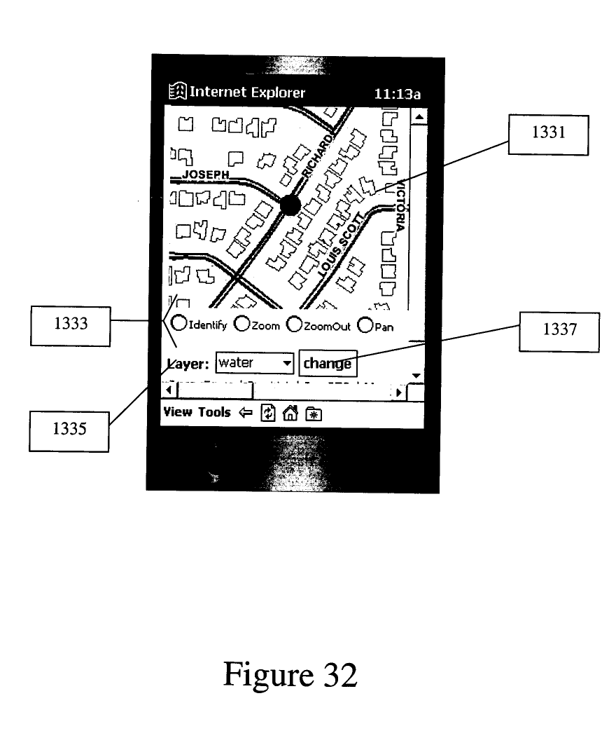

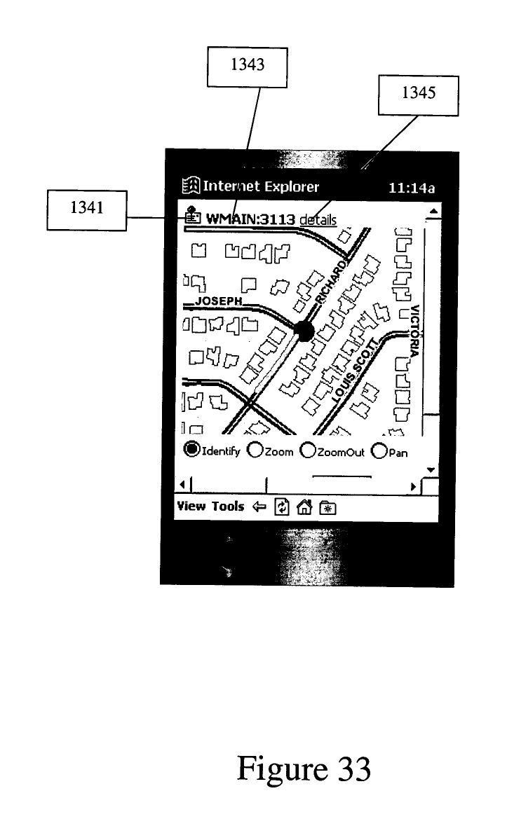

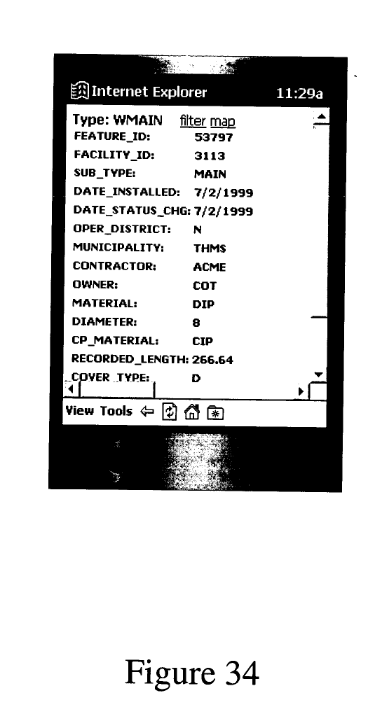

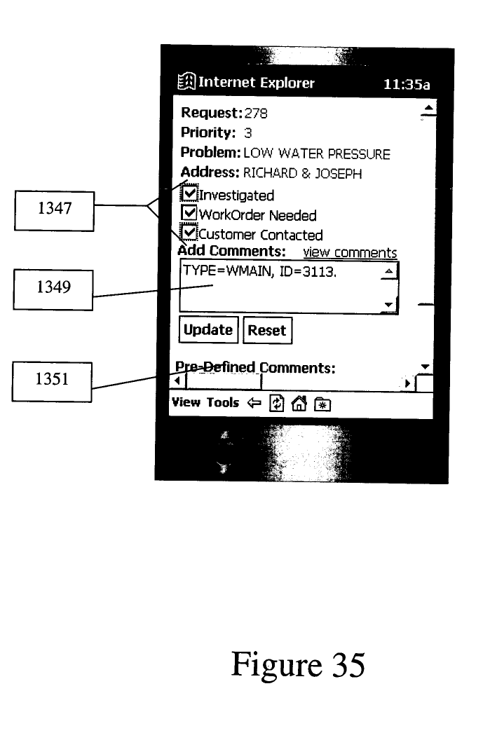

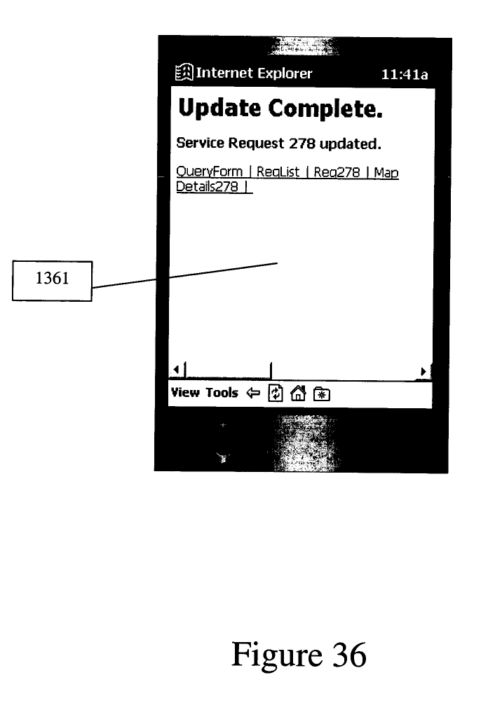

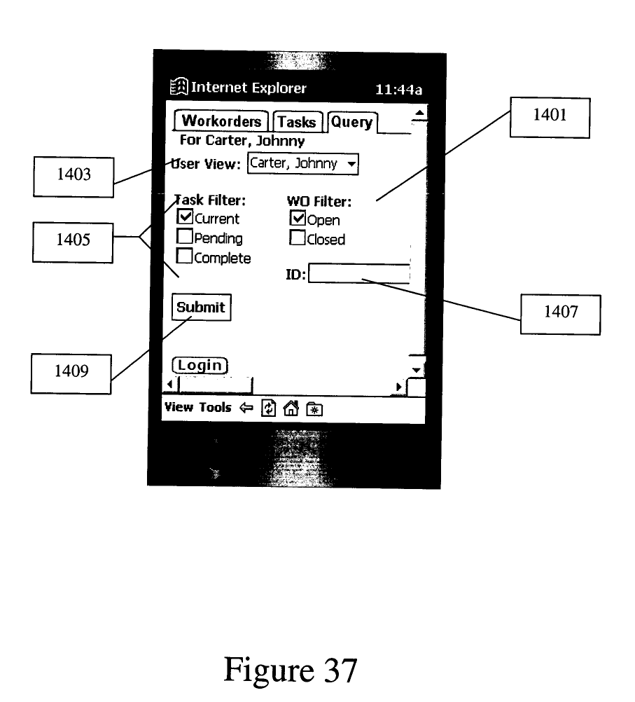

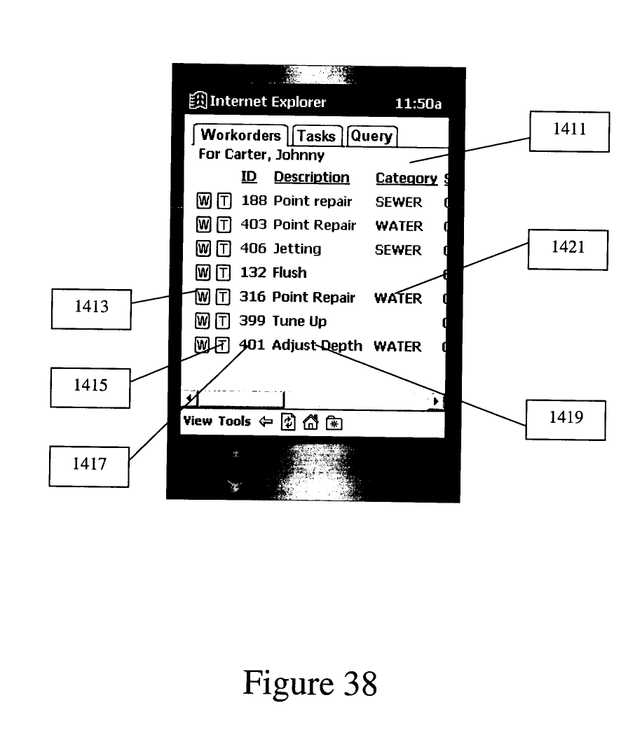

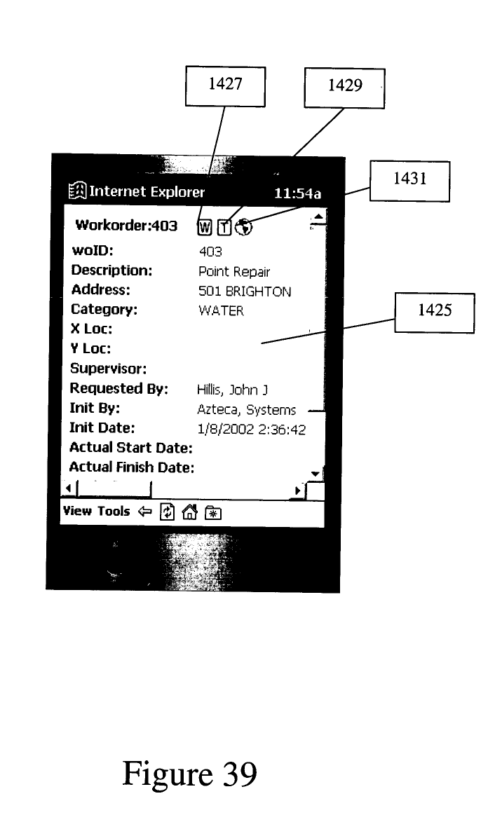

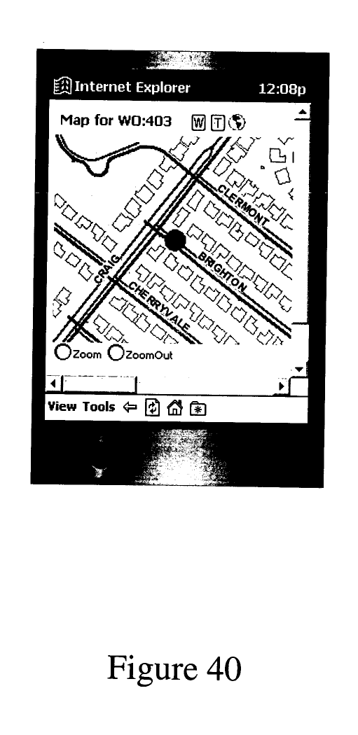

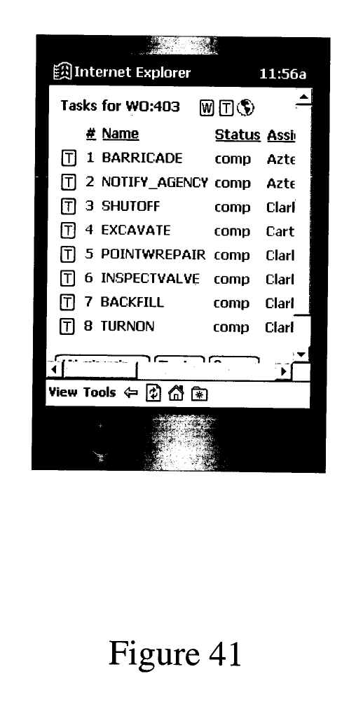

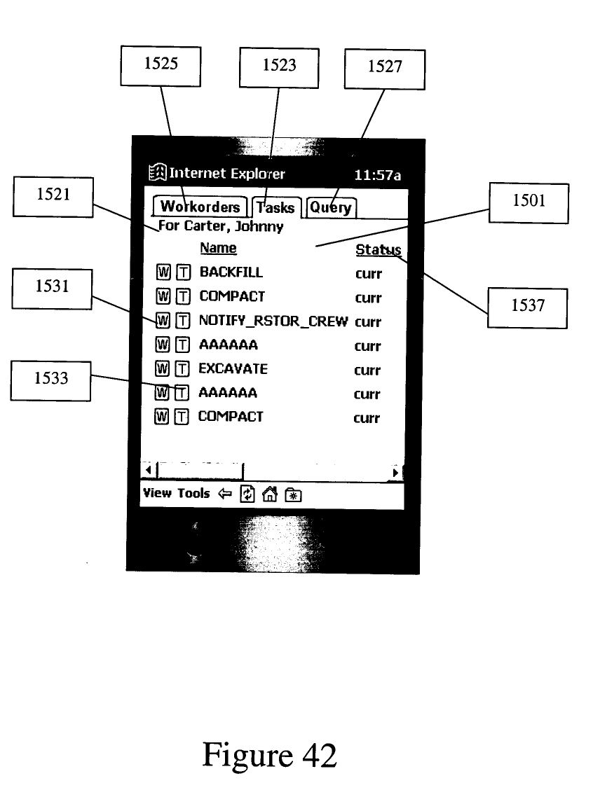

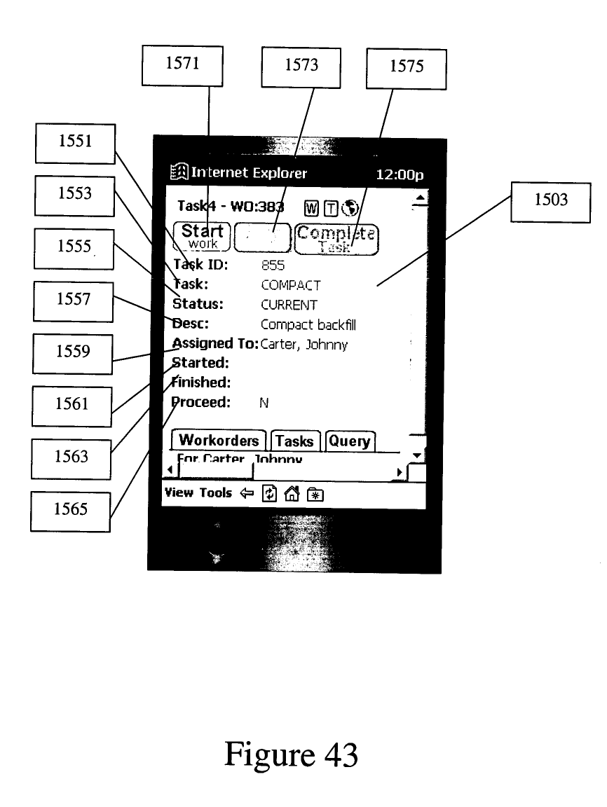

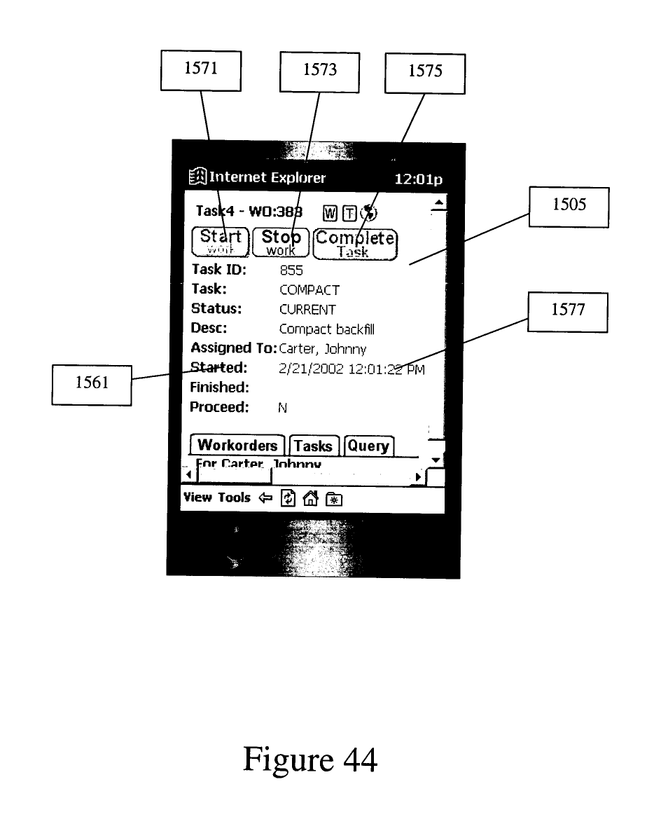

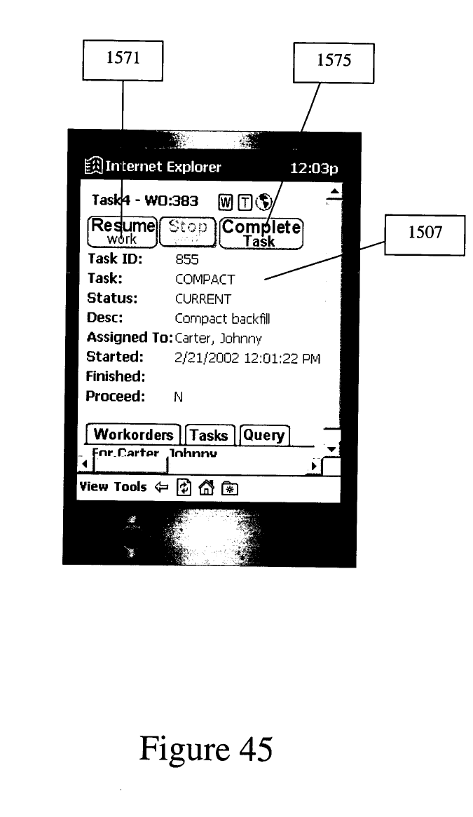

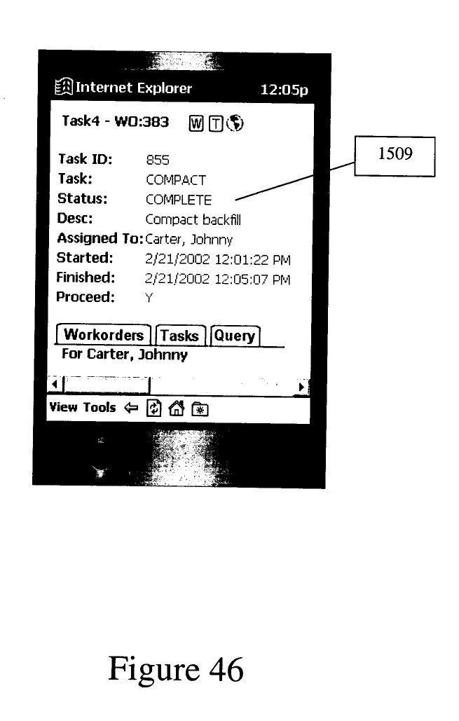

FIG. 25 is a flowchart representation of one implementation of a wireless end device in accordance with one embodiment of the present invention. The process starts at block 1121 and continues at block 1123 in which an introductory screen presented to a user. The introductory screen is depicted in FIG. 26A. The field worker selects a subject matter for which interaction is required with the remotely located server through the wireless channel. Once he or she selects a subject matter, a log-in screen is presented similar to that depicted in FIG. 27A. The field worker enters the log-in ID and password associated with him or her in the appropriate fields. This may be done utilizing the touch screen keypad which is a conventional component of a Compaq iPAQ device. The wireless device returns this data to the server and the server examines the log-in ID and password to permit or deny access to the data. If access is permitted, the selected functional screen is returned. In the view of FIG. 25, the return of the log-in data and password to the server is identified by step 1127. Confirmation of the log-in is identified by step 1129. Posting the appropriate screen is depicted in block 1131. The plurality of functional screens are displayed in the view of FIG. 25. One is a service request screen 1133. The others include work order function screen 1135, tasks function screen 1137, inspection and testing screen 1139, and queries screen 1141.

The operations depicted in the high level overview of the flowchart in FIG. 25 will be described in greater detail below with respect to FIGS. 26A through 46. The views of 26A through 46 are not photographed or represented as being displayed on a Compaq iPAQ device such as the screens of FIGS. 21, 22,and 23. These screens are screen shots from a desktop personal computer running Microsoft Pocket PC emulator. This was done to facilitate the presentation as capturing screen shots directly from the iPAQ is difficult. The layout size of the screen in the emulator is similar to that of the iPAQ device. One difference is the emulator does not include the URL address fields 1047 of FIG. 21. Otherwise, the depictions of FIGS. 26A through 46B provide relatively good depictions of the screens.

FIG. 26A is a representation of the home page associated with a particular internet-accessible database site which can be accessed utilizing the wireless portable handheld devices, such as a Compaq iPAQ device which communicates through towers utilizing a CDPD protocol in order to exchange data between the wireless handheld devices and a centralized server which maintains the data and GIS information for an infrastructure management system. As is shown, a banner 1183 is provided which identifies the site. Additionally, a plurality of menu items 1181 are provided. Each is an active wireless internet link which can be selected through location of the graphical pointing device above the active menu item and a clicking of the graphical pointing device. As is shown, the menu includes service requests menu item 1185, work orders menu item 1187, tasks menu item 1189, inspection/test menu item 1191, and queries menu item 1193. Note that these correspond to the blocks of the flowchart of FIG. 25. The following screen shot representations will represent the interaction between the field worker and the centralized server.

FIG. 26B is a flowchart representation of the process utilized by a field worker and the system in order to gain access to the site and obtain a return of the site's home page. The process begins at block 1151 and continues at block 1153, wherein the field worker turns the wireless device to an on condition. Next, in accordance with block 1155, the worker activates the browser in the wireless portable communication device. Then, in accordance with block 1157 the worker enters the URL for the server website. In accordance with block 1159, the worker selects the site by depressing the “Go” button which is a standard part of the Internet Explorer graphical user interface for the browser. Then in accordance with block 1161, the wireless device utilizes a CDP protocol to access the website through the tower system. In accordance with block 1163, the server and its associated site returns to the wireless device the HTML or XML instructions which are utilized by the wireless handheld portable device to construct the home page in its display. The communication between the website and the wireless end device occurs utilizing the CDP protocol, or any other conventional coding protocol. It is important to note that the wireless device receives CDPD coded HTML or XML instructions which are utilized to “paint” the screen, orient the text, general check boxes, general drop down menus, and the like, all in a manner which is conventional to standard HTML internet programming. The wireless device posts the home page to its display and then awaits operator input in accordance with step 1165. Then, in accordance with step 1167, the worker selects a menu item. The device records the selection and then utilizes the CDPD protocol to communicate the selection through the tower system to the server and its associated website all in accordance with step 1169. In response to the selection, the server returns to the wireless device through the tower system a log-in screen utilizing the CDPD wireless protocol. Once again, the instructions received by the wireless device are in either HTML or XML format and are utilized by the wireless device to construct the log-in screen by painting the screen, generating and orienting the text boxes, drop-down menus, and buttons. The process ends at block 1173.

FIG. 27A is a depiction of the log-in screen which has been returned by the server and associated site to the wireless portable communication device. As is shown, two fields 1201, 1203 are provided in the display. One is associated with the log-in ID and is identified by the text “log-in ID.” The other is associated with the password and it is identified with the text 1207 which reads “password.” A button 1209 is provided which may be selected and thus actuated through touch screen interaction. In operation, the user will use the text screen to select icon 1211 which generates a screen pop up of a touch screen keyboard which is utilized through touch screen interaction to select characters. This is a conventional data input which is found on the Compaq iPAQ device and other conventional systems such as the Palm Operating System.

FIG. 27B is a flowchart representation of the process utilized by the worker to interact with the log-in screen and to provide log-in information to the server through wireless, browser-based communication between the wireless end device and the server. FIG. 27B is a flowchart representation of the utilization of the log-in screen of FIG. 27A. The process starts at block 1221 and continues at block 1223, wherein the worker locates the cursor for the wireless handheld device end field 1201. Then in accordance with block 1225, the worker activates the touch screen keyboard through the touch screen selection of icon 1211. This results in the generation of a tiny alphanumeric keyboard which may be utilized through touch screen interaction to enter data. Next, in accordance with block 1227, the worker utilizes the touch screen keyboard to enter his or her log-in ID in log-in ID field 1201. Then, in accordance with block 1229, the worker locates the cursor in field 1203 through touch screen interaction with his or her device. In accordance with block 1231, the worker utilizes the touch screen keyboard to enter his or her password. Next, in accordance with block 1233 the worker utilizes the “log-in” button 1209 to send the log-in ID and password information from the wireless handheld device, through the tower system, to the internet accessible site associated with the server. This is done in the preferred implementation of the present invention utilizing any conventional CDP protocol. In accordance with the preferred implementation of the present invention, the wireless handheld devices and the site interact with one another in the same way that a computer will interact with an Internet site, namely through the transmission of HTML or XML instructions. This is done in accordance with step 1235. Then in accordance with step 1237, the server checks the log-in data. If the user is an authorized user, the server returns the selected page in accordance with step 1239 and the process ends at step 1241.

FIGS. 28 through 36 are utilized to depict and describe the utilization of the service request menu item of FIG. 26A. This is in contrast with the views of FIGS. 37 through 41 which depict the utilization of the work order menu item 1187 of FIG. 26A. FIGS. 42 through 46 depict the utilization of the task menu item 1189 of FIG. 26A.

### PROCESSING SERVICE REQUESTS UTILIZING THE WIRELESS DEVICE

FIG. 28 depicts one type of service request page 1251, while FIG. 29 depicts an alternative type of service request form 1271. The difference between the service request forms of FIG. 28 and FIG. 29 is that FIG. 28 corresponds to a form for requesting information about service requests which are essentially organized around the identity of a worker. In contrast, page 1271 of FIG. 29 is a form which requests information organized around a truck or truck route. In both FIGS. 28 and 29, icons 1261, 1263 are provided. These are active icons which may be selected in order to switch between the pages of FIGS. 28 and 29. In other words, if one were in the view of page 1251, but wanted to review or examine service request information organized around trucks or truck routes, the worker would select the active icon 1261 which would cause wireless interaction between the wireless end device and the server website to return page 1271 of FIG. 29. Likewise, if the user were viewing page 1271 of FIG. 29 he or she could depress icon 1263 which is an active link. This would cause wireless interaction between the wireless end device and the server website in a manner which returns page 1251 of FIG. 28.

Referring now to FIG. 28, a user field 1253 is provided. Preferably, this is in the form of a drop down menu which has the names of the relevant workers. A worker may utilize the graphical pointing device to select his or her name from a drop down menu and located in this field 1253. A plurality of check boxes 1255 are provided which provide filters for the retrieval and presentation of data. In the preferred implementation, four check boxes are provided including: not investigated, open, investigated, and closed. In this manner, the operator may select for review service requests which have not been investigated and are open. In this manner, he or she would then avoid having to review service requests which have been investigated and/or closed. Field 1257 is provided which has associated with it a drop down menu which provides sorting and presentation options for the return data. A drop down menu will provide a variety of ways of organizing the data. For example, in the view of FIG. 28, the user has selected a sorting by “priority.” The priority is the importance or significance attached to a service request. As you may recall, this was a established during the interaction between the operator and a customer utilizing the call center module 51 of FIG. 1. Page 1251 has associated with it a “submit” button 1259. This is utilized by the operator to submit the request for service request data in accordance with the information provided in the fields.

FIG. 29 depicts page 1271 which includes fields suitable for requesting service request data from the server. As is shown, page 1271 includes a truck field 1273 and a shift field 1275. In the implementation depicted, shift field 1275 includes a drop down menu associated with it which identifies the various shifts which may be utilized for retrieving, sorting, and presenting service request information. Check boxes 1277 provide similar filter options as those found in page 1251 of FIG. 28. Additionally, sort by field 1279 has associated with it a drop down menu which allows the operator to select a sorting methodology. Submit button 1281 is provided to allow the communication of these selections from the wireless handheld device to the server website. As stated above, this is accomplished through the wireless communication of HTML and/or XML instructions over a wireless tower system utilizing a CDPD encoding protocol. The server website returns the information in the form of HTML instructions.

FIG. 30 is a view of data returned in response to a query organized or relating to a truck or truck route. The data is communicated from the server website to the wireless end device utilizing the tower system. The tower system communicates HTML or XML instructions encoded in CDPD format for receipt by the wireless end device. The wireless end device receives the HTML or XML instructions and constructs the page 1291 which is depicted in the view of FIG. 30. Page 1291 is a representation of service request data organized around truck identity and truck route. The data is presented in column format. Column 1301 receives an iconic representation of the nature of the data elements. In the view of FIG. 30, all the items are service requests so they all carry the icon “R” to designate that they are service requests. Column 1305 provides a brief description of the nature of the request. Column 1307 provides a job number for each request. Column 1309 is a field which accepts additional information relating to the service request. Each of these items is an active link. Clicking on these links will cause wireless communication between the wireless end device and the server site. This will cause the server site to return data utilizing HTML or XML instructions which are processed by the end device and displayed on the display, all in a manner similar to that utilized by computers interacting with one another over the internet.

FIG. 31 depicts page 1311 which is a request screen which allows the field worker to enter data related to his or her investigation of the situation. The page includes an address field 1315 which receives the address information of the asset in question. The page 1311 further includes check boxes 1313 which allow the field worker to check an appropriate box from the following available choices: investigated, work order needed, and customer contacted. Additionally, comment field 1317 is provided to allow the field worker to add his or her comments utilizing the touch screen keypad to generate human readable text. Buttons 1319, 1321 are provided in page 1311 to allow the operator to reset this page (to start over, in other words) or to “update.” Update button 1319 initiates wireless communication between the wireless end device and the server site which provides the information posted to this page 1311 to the server. When the information is received, it is posted to the database, thus synchronizing a data content of the wireless handheld device and the centralized server system. This in effect “synchronizes” the data between the plurality of wireless end devices and the server. In practice, a large number of field workers may be moving about their service areas investigating assets in response to service calls. Those familiar with water assets will be responding to water related service calls, while those familiar with other assets such as traffic assets will be responding to service calls relating to the assets of a traffic system, such as stop lights. Each worker will intermittently communicate with the central server through the server website over the wireless communication link utilizing the wireless handheld devices. Each worker may retrieve service requests, may investigate the purported or alleged problem, and report back in the form of a wireless communication through the browser, utilizing encoded HTML or XML code and the TCP/IP protocol. In the view of FIG. 31 a predefined comment field 1323 is provided which has associated with it a drop down menu with a plurality of predefined comments. This may be utilized by the field worker instead of utilizing the touch screen keypad which is sometimes difficult to use. Additionally, in page 1311, a plurality of links 1325 are provided to allow connection to a page which provides a query form, a page which provides a service request list, a page which provides information concerning this particular service request number 278, map data associated with the service request, and a detailed identification of information relating to service request 278.

FIG. 32 is a representation of map page 1331 which is accessed utilizing the map link in the page 1311 of FIG. 31. This map data corresponds to the address of the screen of FIG. 31 which is Richard & Joseph. This map shows the intersection of Joseph Street and Richard Street. The asset is located at this intersection. The plurality of map navigation buttons 1333 are provided to allow the identification function, zooming-in, zooming-out and panning. These are conventional functions. Layer field 1335 is provided which has associated with it a drop down menu of the various layers (views or polygons) which are available. As is shown in the view of FIG. 32, the present view of a “water view.” In order to change the view, the user must select an alternative view from the drop-down menu, load that view to the field 1335, and click on the “change” button 1337. This will result in a change of views. A view may be changed from any available view to any other available view. For example, a water view may be changed to a traffic asset view, or a parks view. These views would identify the traffic assets from the same location, or park assets in the same location.

FIG. 33 depicts the utilization of the “identify” function of FIG. 32. This identify function is similar to the identify function available in the server-based call center module 51 of FIG. 1. However, it is “scaled down” to present data on the relatively small display of the wireless communication device. As is shown in the view of FIG. 33, the cursor had been located on the asset, and a message 1341 is displayed at the top of the screen. In this particular instance, the message reads “WMAIN:3113.” A “post” icon 1343 is provided adjacent this description and is utilized to “write” or “post” this information to the report. Clicking on this icon 1343 results in information being posted to a particular field on an associated form. Adjacent this description is a “details” link 1345. Clicking on this link will generate a screen such is depicted in FIG. 34 which is largely a text-based description of the asset.

Of course, the generation of these screens is accomplished through the wireless communication between the portable communication device and the server site utilizing HTML or XML code which has been encoded utilizing a conventional wireless coding technology such as CDPD. This type of information is similar to the type of detailed information which may be generated from the asset management software at the server or a network terminal.

FIG. 35 depicts a request screen which allows the field worker to identify the work performed in response to this service request. As is shown, check boxes 1347 are provided which may be actuated utilizing the end device. In this example, the options include check boxes for: investigated, work order needed, and customer contacted. Additionally, a comments field 1345 is provided which may receive text and information which is typed utilizing the touch screen, or which is posted to this field utilizing the “post” icon. A menu of predefined comments 1351 may be provided to allow for the easy entry of data to the comments field.

FIG. 36 is a view of a confirmation page 1361 which is passed from the server website to the wireless communication device in response to the updating of the database. In other words, once the field data has been synchronized with the network data, the wireless end device receives HTML or XML instructions which generate the update completed page 1361 which is dedicated in FIG. 36. This provides positive confirmation to the user that the information has been integrated into the database. In other words, the information generated during the service request has been posted to the database and is available for anyone having access to retrieve and view the status of this particular service request.

One feature of the present invention which his not visible from the black and white drawings is the utilization of color to indicate urgency. In accordance with the preferred scheme, colors are utilized to code items for their importance. The preferred convention utilizes red to indicate a very hot or urgent item. Green indicates a medium urgency. Blue indicates a lesser urgency. Yellow indicates the lowest level of urgency. Items may be arranged by color in the graphical user interfaces of the wireless end device. This is not clear from the black and white drawings but is part of the present invention.

Additionally, in the present invention, the map data is transmitted from the server website to the wireless end devices over the tower network utilizing GIF files. These are relatively easy to transmit, and they utilize color to a significant degree. This is also not present in black and white drawings of the application, but the map data of the present invention is in color which allows for a relatively granular (low resolution) screen to be utilized to depict the map information. In other words, the utilization of color offsets the negative impact of using a relatively small screen which has relatively few pixels available.

### UTILIZATION OF THE WIRELESS END DEVICE FOR WORK ORDER FUNCTIONS

FIGS. 37 through 41 depict the utilization of the wireless end device to perform functions related to work orders. FIG. 37 depicts a page 1401 for the generation of information relating to work orders. The particular task represented is a “query task.” The user view may be selected through user view field 1403 which may be populated with a data element selected from a drop-down menu. A plurality of check boxes 1405 are provided which provide filters for the request for data. In the example of FIG. 37, the check boxes include task filters such as current, pending and complete, as well as work order filters for open and closed work orders. ID field 1407 allows the work orders to be searched utilizing an ID number. “Submit” button 1409 is utilized to pass the query information from the end device over the wireless network to the server website. The server website will return the data in the form of HTML or XML instructions which are executed upon by the wireless end device in order to generate page 1411 of FIG. 38.

In this view, the work order data is presented in a manner similar to the service request information. The data is presented in tabular form with rows and columns representative of information. Columns include columns 1413, 1415 which display icons representative of work orders and tasks associated with each row. An ID column 1417 is provided as well as a description column 1419. The category column 1421 is also provided. Some of these columns include data items which are active or live links to other data.

If the worker were to select the second row which corresponds to ID number 403, and click on that item, the page 1425 of FIG. 39 is returned by the server website. This contains detailed information about work order 403. Icons 1427, 1429, 1431 are provided at the top of page 1425 and are representative of live links. Icons 1427 may be utilized to connect to the work order 403. Icon 429 may be utilized to identify tasks associated with this work order. Icon 1431 may be utilized to access map data associated with this particular work order.

In the example of these views, once the worker clicks on icon 1431, the map of FIG. 40 is displayed which is a map screen for the particular work order of FIG. 39. FIG. 41 depicts a page which is generated when the task icon of either FIG. 39 or FIG. 40 is actuated. This identifies all the tasks which are associated with that particular work order. The tasks include a number, name, status, and assignment information.

### UTILIZATION OF THE WIRELESS DEVICE FOR HANDLING TASK INFORMATION

FIGS. 42 through 46 depict the utilization of the wireless communication device to handle task information. FIG. 42 depicts a view of tasks for a particular user. Once again, the data is presented in tabular format with rows and columns representative of types of data or data items. Icons are provided to identify each of the elements with a work order and a task. A name is provided for each task. A status column is also provided for each task. If an item is selected, the wireless end device communicates through the tower system to the server website and the server website returns the requested information. In the example of FIGS. 42 and 43, the second row is selected for additional information. The server website returns the information in the form of a page as is depicted in FIG. 43. This provides more complete identification of the task.

With reference now to FIG. 42, in this view the wireless end device displays a page 1501 which identifies the tasks for a user 1521 which is identified as Johnny Carter. A plurality of tabs 1523, 1525, 1527 are provided along the top of the display. These are active links to other views or pages. One tab includes the text “work orders.” Another tab includes the text “query.” The present view is controlled by tab 1523 which includes the text “tasks.” The tasks are presented in a tabular format with columns responding to similar types of information, and with rows corresponding to particular items in the database. For example, rows 1531, 1533 correspond to active links to the work order and task information related to each of the items arranged in rows. Name field 1535 is populated with textual data which identifies the name of the task. Status field 1537 is populated with data which identifies the status of the particular task. Each of these items (or rows) in this task database may be accessed through these links. For example, if the user were to select the second item in the row, “compact,” then the page 1503 of FIG. 43 would be retrieved from the server website via the wireless communication device and tower network.

Page 1503 of FIG. 43 is this particular task. It has associated with it a number of data elements, some of which are complete, and some of which are incomplete. These include task ID field 1551, task field 1553, status field 1555, description field 1557, assign to field 1559, started field 1661, finished field 1563, proceed field 1665. Buttons 1571, 1573, 1575 are provided to allow the field worker to record start times for starting work, stop times for stopping work, and the completion time for the completion of the task. Note that the start field 1561 and finished field 1563 do not carry any time or date data. This indicates that the particular task has not been started and has not been finished. The field worker may utilize buttons 1571, 1573, 1575 to post the date and time to the start field. This is depicted in FIG. 44. As is shown, the start work button 1571 has been actuated. This causes the internal date time clock of the end device to post the date and time information to the start field 1561. If the work is interrupted, button 1571 replaces the text “start work” with “resume work.” In this manner, a worker may start a task, stop it for a short while, and then restart the task. All the while, the wireless end device is keeping track of the amount of time that has been expended by the worker on the particular task. Once the task is completed, the operator actuates the completed task button 1575. This generates page 1509 of FIG. 46 which includes date and time information for the start and finish fields. This feature is convenient in that it allows management to track the allocation of effort on particular tasks. This becomes beneficial for exact accounting on a task basis for work performed in a work order. The granularity provided by tracking the start and stop times for individual task items is advantageous as it allows the infrastructure management software of the present invention to comply with government standards such as GASB 34 (Governmental Accounting Standards Board Statement No. 34).

### THE PRESENTATION OF MAP INFORMATION

In the present invention, the presentation of map information on the wireless end device presents some difficulty. The 2″×2″ display on the Compaq iPAQ device is relatively small in comparison to the ordinary map displays. The GIS system keeps track of map information through the use of a longitude and latitude coordinate system (representing an x axis and a y axis). The display for the handheld communication device is a 2″×2″ square which is defined in terms of HTML code by an x axis and a y axis having its origin at the upper leftmost corner of the display. In the view of FIG. 47, this is annotated as (0,0). The x axis runs across the device from left to right, and y axis runs down the device from top to bottom. The map data which is passed to the wireless end device must center the feature at x, y which is the centerpoint of the display. As the cursor is moved about within the display, the wireless end device must be able to determine its position relative to this coordinate system. If the user actuates the graphical pointing device at a particular location within the display, this must be related back to the server website in a meaningful manner. Accordingly, when the server website passes map information over the tower system to the wireless end device, it must maintain the relationship between the centerpoint x, y in terms of latitude and longitude and the available display space in terms of x pixels across and y pixels down from an origin at the leftmost corner of the display and with the asset located at a midpoint x, y in the middle of a display. The server maintains the map data in a model so that, when HTML code is returned which indicates that the cursor has moved to another location, the server will be able to identify that location in terms of latitude and longitude and push back to the wireless end device a refreshed image which has the new centerpoint in the position of the cursor. In the preferred embodiment of the present invention, the correlation from these two mapping systems is maintained on the server, and not on the wireless end device. This is consistent with the general concept of the present invention which is to utilize an out-of-the-box wireless end device and a conventional browser, neither of which is modified in any respect except for the inclusion of a conventional CDPD wireless communication card (or similar communication card for alternative technologies). This out-of-the-box, plug-and-play functionality is essential to the success of the present invention. This means that municipalities can purchase from electronic wholesalers wireless end devices which are absolutely unmodified in any respect, and that they can use them in their infrastructure management systems utilizing their proprietary or internal server and data. This provides a significant advantage over the prior art.

What is claimed is:

1. A method of managing work orders, comprising:
(a) providing a call center for receiving requests for service;
(b) providing a database for maintaining information concerning service assets;
(c) providing a wireless communication system;
(d) providing a plurality of wireless handheld devices which are issued to service personnel, and utilizing said wireless handheld devices with said wireless communication system in order to communicate with said database and said call center, to allow distribution of work orders and the gathering of asset information.
